(19) United States
(12) Patent Application Publication
(10) Pub. No.: US 2021/0081926 A1
(43) Pub. Date: Mar. 18, 2021

(54) INFORMATION PROCESSING DEVICE, MANAGEMENT SERVER, INTERMEDIATE SERVER, AND INFORMATION PROCESSING METHOD

(71) Applicant: FeliCa Networks, Inc., Tokyo (JP)

(72) Inventor: Tomoyo NAGAYAMA, Tokyo (JP)

(73) Assignee: FeliCa Networks, Inc., Tokyo (JP)

(21) Appl. No.: 16/620,301

(22) PCT Filed: Jul. 5, 2018
(86) PCT No.: PCT/JP2018/025503

§ 371 Date: Dec. 6, 2019

(30) Foreign Application Priority Data
Aug. 30, 2017 (JP) 2017-165227

(51) Int. Cl. G06Q 20/32; G06Q 20/04; G06Q 20/36; G06Q 20/38

(52) U.S. Cl. CPC G06Q 20/3278; G06Q 20/0457; G06Q 20/381; G06Q 20/3672; G06Q 20/3676

(57) ABSTRACT

There is provided an information processing device, a management server, an intermediate server, and an information processing method that allow an electronic value to be easily transferred between individuals. The information processing device includes a first memory unit, a reader/writer, a communication unit, a control unit, and an application. On the first memory unit, an electronic value is recorded. The reader/writer performs near field communication with communication equipment including a second memory unit on which an electronic value is recorded. The communication unit performs communication with a management server. The control unit controls transfer of the electronic value to the communication equipment via the reader/writer, and also controls deletion and addition of electronic values from/to the first and second memory units based on an instruction received from the management server. The application causes a user interface related to the transfer of the electronic value to be displayed on a display unit.

### TECHNICAL FIELD

The present technology relates to an information processing device, a management server, an intermediate server, and an information processing method for transferring an electronic value between individuals.

### BACKGROUND ART

In recent years, systems that use the automatic ticket gates of stations or make payments for goods at shops by electronic money under the technology of near field communication by terminal equipment such as cards and mobile phones including an IC chip are becoming pervasive. The near field communication is communication made available when cards or terminal equipment and readers/writers are caused to get close to each other by about 10 cm or less. The cards or terminal equipment store monetary values such as electronic money, and making payments for rides or goods by electronic money is allowed when the cards or terminal equipment is held over readers/writers at the automatic ticket gates of stations or shops.

The exchange of electronic values between such terminal equipment including an IC chip has been discussed (see, for example, Patent Literature 1). It is described in Patent Literature 1 that electronic values issued by different managers and stored in communication terminals are exchanged for each other when the exchange is authenticated by an identification server on the basis of identifiers transferred between users. Further, it is described in Patent Literature 2 that a user makes a payment for goods by electronic money at a shop, and that the provision of an intermediate server for exchanging different electronic money allows the user to make a payment to the shop by electronic money different from electronic money retained by himself/herself.

### CITATION LIST

### Patent Literature

Patent Literature 1: Japanese Patent Application Laid-open No. 2008-257439

Patent Literature 2: Japanese Patent Application Laid-open No. 2007-41673

### DISCLOSURE OF INVENTION

### Technical Problem

In the technologies described in the above Patent Literatures, it is described that electronic money is exchanged for electronic money of another type. In Patent Literature 1, different pieces of terminal equipment each have to access a server. In Patent Literature 2, a payment side and a shop each have to access a server.

In view of the above circumstances, it is an object of the present technology to provide an information processing device, a management server, an intermediate server, and an information processing method that allow an electronic value to be easily transferred between individuals.

### Solution to Problem

In order to achieve the above object, an information processing device according to the present technology includes a first memory unit, a reader/writer, a communication unit, a control unit, and an application.

On the first memory unit, an electronic value is recorded.

The reader/writer performs near field communication with communication equipment including a second memory unit.

The communication unit performs communication with a management server.

The control unit controls transfer of the electronic value to the communication equipment via the reader/writer.

The application causes a user interface related to the transfer of the electronic value to be displayed on a display unit.

On the basis of an instruction received from the management server via the communication unit in accordance with an operation of the application, the control unit deletes the electronic value corresponding to an amount of the transfer from the first memory unit, and transmits an instruction to the communication equipment via the reader/writer, the instruction transmitted to the communication equipment being an instruction to add an electronic value corresponding to the amount of the transfer to the second memory unit of the communication equipment.

According to such a configuration, the information processing device is allowed to perform near field communication with the communication equipment using the reader/writer and transmit an instruction from the management server to the communication equipment via the reader/writer to rewrite the data of the second memory unit. Accordingly, the communication equipment does not have to access the management server, and an electronic value is allowed to be easily transferred between individuals only with the information processing device held over the communication equipment.

The control unit may activate the reader/writer on the basis of the instruction received from the management server via the communication unit in accordance with the operation of the application.

The transfer of the electronic value may include transferring the electronic value after converting the electronic value into an electronic value of a different type.

As described above, an electronic value recorded on the first memory unit is allowed to be transferred to the second memory unit after being converted into an electronic value of a type different from the electronic value.

The first memory unit may be configured to be capable of recording first electronic money as the electronic value. The second memory unit may be configured to be capable of recording second electronic money of a type different from the first electronic money. On the basis of the instruction received from the management server via the communication unit in accordance with the operation of the application, the control unit may delete the first electronic money corresponding to an amount of transfer from the first memory unit, and transmit an instruction to the communication equipment via the reader/writer, the instruction that may be transmitted to the communication equipment being an instruction to add, to the second memory unit, second electronic money into which the first electronic money corresponding to the amount of the transfer has been converted.

According to such a configuration, first electronic money is allowed to be transferred after being converted into second electronic money of a different type. Even if the information processing device and the communication equipment retain only electronic money of a different type each other, the transfer of the electronic money is allowed. Therefore, usability is excellent.

The first memory unit may be configured to be capable of recording first electronic money and an electronic ticket as the electronic values. The second memory unit may be configured to be capable of recording second electronic money of a type different from the first electronic money and the electronic ticket. On the basis of the instruction received from the management server via the communication unit in accordance with the operation of the application, the control unit may delete the first electronic money corresponding to an amount of transfer from the first memory unit, add the electronic ticket to the first memory unit, and transmit an instruction to the communication equipment via the reader/writer, the instruction that may be transmitted to the communication equipment being an instruction to add, to the second memory unit, second electronic money into which the first electronic money corresponding to the amount of the transfer has been converted, and delete the electronic ticket from the second memory unit.

According to such a configuration, the resale of an electronic ticket is allowed by the transfer of the electronic ticket and the transfer of electronic money.

The electronic value may be an electronic ticket.

As described above, electronic money is not transferred, but only an electronic ticket may be transferred.

The electronic value may be a coupon.

Communication equipment according to the present technology includes a near field communication unit and a second memory unit.

The near field communication unit performs near field communication with a reader/writer of an information processing device, the information processing device including a first memory unit on which a first electronic value is recorded and the reader/writer and performing communication with a management server.

On the second memory unit, a second electronic value of a type different from the first electronic value is recorded.

The second electronic value corresponding to an amount of transfer is added to the second memory unit via the reader/writer in accordance with an instruction from the management server provided on the basis of a request to transfer an electronic value from the information processing device, the transferring the electronic value including converting the first electronic value recorded on the first memory unit into the second electronic value and transferring the second electronic value to the second memory unit.

According to such a configuration, it becomes possible to rewrite the data of the second memory unit of the communication equipment with the information processing device via the reader/writer in accordance with an instruction from the management server. Thus, the communication equipment does not have to directly access the management server and is allowed to easily receive an electronic value from the information processing device.

A management server according to the present technology includes a communication unit and a processing execution unit.

The communication unit receives a request to transfer an electronic value from an information processing device, the transferring the electronic value including transferring the electronic value recorded on a first memory unit of the information processing device including a reader/writer and the first memory unit on which the electronic value is recorded to a second memory unit of communication equipment that performs near field communication with the reader/writer and includes the second memory unit.

The processing execution unit instructs, on the basis of the request to transfer the electronic value, the information processing device to delete the electronic value corresponding to an amount of transfer from the first memory unit, and add the electronic value corresponding to the amount of the transfer to the second memory unit of the communication equipment.

According to such a configuration, it becomes possible to rewrite the data of the second memory unit of the communication equipment with the information processing device via the reader/writer in accordance with an instruction from the management server. Thus, the communication equipment does not have to directly access the management server and is allowed to easily receive an electronic value from the information processing device.

The first memory unit may be configured to be capable of recording first electronic money as the electronic value. The second memory unit may be configured to be capable of recording second electronic money of a type different from the first electronic money. On the basis of a request to transfer electronic money from the information processing device, the transferring the electronic money including converting the first electronic money recorded on the first memory unit into the second electronic money and transferring the second electronic money to the second memory unit, the processing execution unit may instruct the information processing device to delete the first electronic money corresponding to an amount of transfer from the first memory unit, and add the second electronic money corresponding to the amount of the transfer to the second memory unit.

According to such a configuration, first electronic money is allowed to be transferred after being converted into second electronic money of a different type. Therefore, usability is excellent.

The first memory unit may be configured to be capable of recording first electronic money and an electronic ticket as the electronic values. The second memory unit may be configured to be capable of recording second electronic money of a type different from the first electronic money and the electronic ticket. On the basis of a request from the information processing device, the request being a request to transfer electronic money and to transfer the electronic ticket to the first memory unit, the electronic ticket being recorded on the second memory unit, the transferring the electronic money including converting the first electronic money recorded on the first memory unit into the second electronic money and transferring the second electronic money to the second memory unit, the processing execution unit may instruct the information processing device to delete the first electronic money corresponding to an amount of transfer from the first memory unit, add the electronic ticket to the first memory unit, delete the electronic ticket from the second memory unit, and add the second electronic money corresponding to the amount of the transfer to the second memory unit.

According to such a configuration, the resale of an electronic ticket is allowed by the transfer of the electronic ticket and the transfer of electronic money.

An intermediate server according to the present technology includes a communication unit and a processing execution unit.

The communication unit receives a request to transfer an electronic value from an information processing device including a reader/writer and a first memory unit on which the electronic value is recorded, the transferring the electronic value including transferring the electronic value recorded on the first memory unit to a second memory unit of communication equipment that includes the second memory unit and performs near field communication with the reader/writer.

The processing execution unit requests, on the basis of the request to transfer the electronic value, the management server to delete the electronic value corresponding to an amount of transfer from the first memory unit, and add the electronic value corresponding to the amount of the transfer to the second memory unit.

According to such a configuration, it becomes possible to rewrite the data of the second memory unit of the communication equipment with the information processing device via the reader/writer in accordance with an instruction from the management server. Thus, the communication equipment does not have to directly access the management server and is allowed to easily transfer an electronic value from the information processing device to the communication equipment.

The first memory unit may be configured to be capable of recording first electronic money as the electronic value. The second memory unit may be configured to be capable of recording second electronic money of a type different from the first electronic money. On the basis of a request to transfer electronic money from the information processing device, the transferring the electronic money including converting the first electronic money recorded on the first memory unit into the second electronic money and transferring the second electronic money to the second memory unit, the processing execution unit may request the management server to delete the first electronic money corresponding to an amount of transfer from the first memory unit, and add the second electronic money corresponding to the amount of the transfer to the second memory unit.

As described above, electronic money is allowed to be transferred after being converted into electronic money of a different type. Therefore, usability is excellent.

The first memory unit may be configured to be capable of recording first electronic money and an electronic ticket as the electronic values. The second memory unit may be configured to be capable of recording second electronic money of a type different from the first electronic money and the electronic ticket. On the basis of a request from the information processing device, the request being a request to transfer electronic money and to transfer the electronic ticket to the first memory unit, the electronic ticket being recorded on the second memory unit, the transferring the electronic money including converting the first electronic money recorded on the first memory unit into the second electronic money and transferring the second electronic money to the second memory unit, the processing execution unit may request the management server to delete the first electronic money corresponding to an amount of transfer from the first memory unit, add the second electronic money corresponding to the amount of the transfer to the second memory unit, delete the electronic ticket from the second memory unit, and add the electronic ticket to the first memory unit.

According to such a configuration, the resale of an electronic ticket is allowed by the transfer of the electronic ticket and the transfer of electronic money.

An information processing method according to the present technology is an information processing method of an information processing device that includes a communication unit, a reader/writer, and a first memory unit on which an electronic value is recorded and performs, using the reader/writer, near field communication with communication equipment that includes a second memory unit on which an electronic value is recorded, the information processing method including: requesting an intermediate server to transfer an electronic value recorded on the first memory unit to the second memory unit via the communication unit; activating the reader/writer; performing near field communication with the communication equipment using the reader/writer; and according to an instruction from the management server provided on the basis of a request made to the management server by the intermediate server in accordance with the request to transfer the electronic value, deleting the electronic value corresponding to an amount of transfer from the first memory unit and transmitting an instruction to the communication equipment via the reader/writer, the instruction transmitted to the communication equipment being an instruction to add the electronic value corresponding to the amount of the transfer to the second memory unit.

An information processing method according to the present technology is an information processing method of a management server that performs communication with an information processing device including a reader/writer that performs near field communication with communication equipment including a second memory unit, and a first memory unit on which an electronic value is recorded, the information processing method including: receiving a deletion request to delete the electronic value corresponding to an amount of transfer from the first memory unit, the deletion request being transmitted from an intermediate server that receives a request to transfer the electronic value from the information processing device, the transferring the electronic value including transferring the electronic value recorded on the first memory unit to the second memory unit; instructing, on the basis of the deletion request, the information processing device to delete the electronic value corresponding to the amount of the transfer from the first memory unit; receiving an addition request to add the electronic value corresponding to the amount of the transfer to the second memory unit, the addition request being transmitted from the intermediate server; and instructing, on the basis of the addition request, the information processing device to add the electronic value corresponding to the amount of the transfer to the second memory unit.

An information processing method according to the present technology is an information processing method of an intermediate server that performs communication with an information processing device and a management server, the information processing device including a reader/writer that performs near field communication with communication equipment including a second memory unit, and a first memory unit on which an electronic value is recorded, the information processing method including: receiving a request to transfer the electronic value from the information processing device, the transferring the electronic value including transferring the electronic value recorded on the first memory unit to the second memory unit; requesting the management server to delete the electronic value corresponding to an amount of transfer from the first memory unit; and requesting the management server to add the electronic value corresponding to the amount of the transfer to the second memory unit.

### Advantageous Effects of Invention

According to the present technology, an electronic value is allowed to be easily transferred between individuals as described above.

Note that the effects described here are not necessarily limitative but any effect described in the present disclosure may be produced.

### BRIEF DESCRIPTION OF DRAWINGS

FIG. 1 shows a configuration example of an information processing system according to a first embodiment.

FIG. 2 is a block diagram showing a function configuration example of a first terminal device constituting the information processing system according to the first embodiment, a purchase-side terminal device according to a second embodiment, and an offer-side terminal device according to a third embodiment.

FIG. 3 is a block diagram showing a function configuration example of a second terminal device constituting the information processing system according to the first embodiment.

FIG. 4 is a block diagram showing a function configuration example of an application server constituting the information processing system according to the first, second, and third embodiments.

FIG. 5 is a block diagram showing a function configuration example of a remote issuance server constituting the information processing system according to the first, second, and third embodiments.

FIGS. 6(A) and 6(B) are diagrams for describing the outline of the information processing system according to the first embodiment.

FIGS. 7(A) and 7(B) are diagrams for describing the outline of the information processing system according to the first embodiment.

FIG. 8 is a sequence diagram showing an operation example of respective devices constituting the information processing system according to the first embodiment.

FIG. 9 shows a configuration example of the information processing system according to the second embodiment.

FIG. 10 is a block diagram showing a function configuration example of a resale-side terminal device constituting the information processing system according to the second embodiment and a reception-side terminal device according to the third embodiment.

FIG. 11 is a diagram for describing the outline of the information processing system according to the second embodiment.

FIGS. 12(A) and 12(B) are diagrams for describing the outline of the information processing system according to the second embodiment.

FIG. 13 is a sequence diagram showing an operation example of respective devices constituting the information processing system according to the second embodiment.

FIG. 14 is a diagram for describing the outline of the information system according to the third embodiment.

FIGS. 15(A) and 15(B) are diagrams for describing the outline of the information processing system according to the third embodiment.

### MODE(S) FOR CARRYING OUT THE INVENTION

Hereinafter, embodiments according to the present technology will be described with reference to the drawings.

In the present technology, the transfer of an electronic value retained by one information processing device to the other information processing device is allowed by performing, for example, near field communication using electromagnetic waves with the one information processing device held over the other information processing device.

### First Embodiment

In the present embodiment, a case in which electronic money serving as an electronic value is transferred between mobile terminal devices serving as different information processing devices will be described as an example. Here, first electronic money serving as a first electronic value retained by one mobile terminal device is converted into second electronic money serving as a second electronic value of a different type and transferred to the other mobile terminal device. Hereinafter, the transfer of electronic money will be described with reference to the drawings.

<Configuration of Information Processing System>

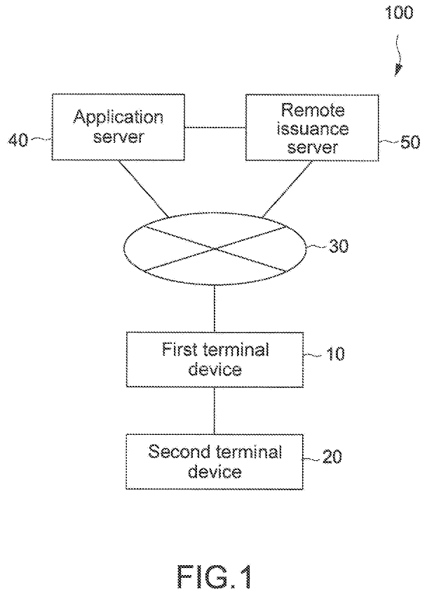

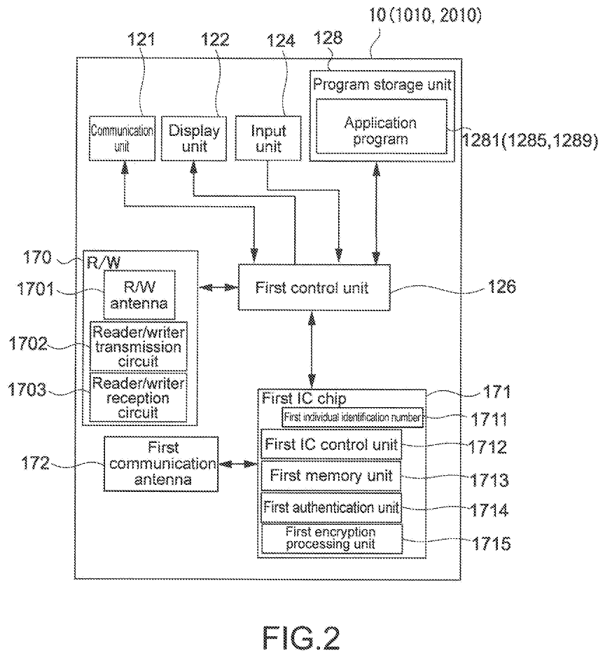

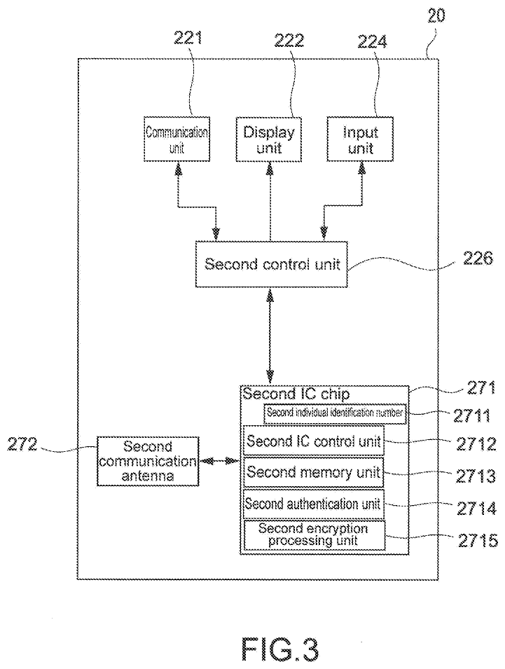

FIG. 1 shows a configuration example of an information processing system according to the present embodiment. FIG. 2 is a block diagram showing a function configuration example of a first terminal device 10 constituting a part of an information processing system 100. FIG. 3 is a block diagram showing a function configuration example of a second terminal device 20 constituting a part of the information processing system 100.

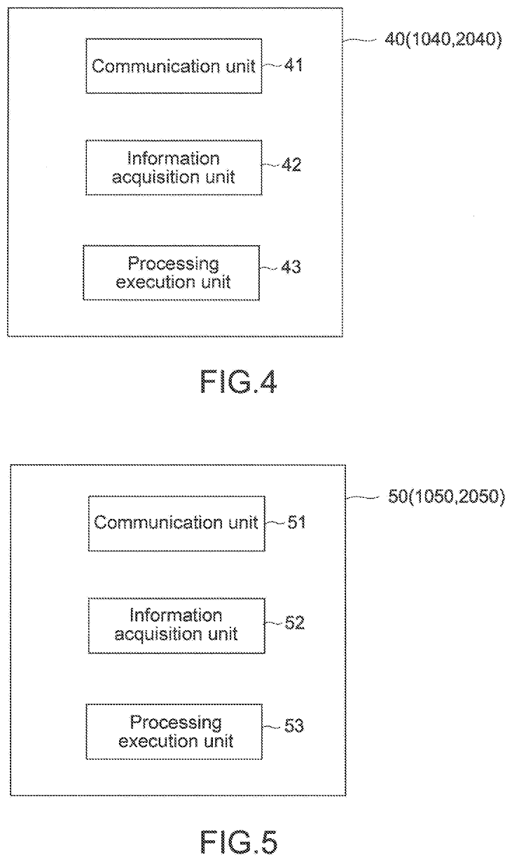

FIG. 4 is a block diagram showing a function configuration example of an application server 40 constituting a part of the information processing system 100. FIG. 5 is a block diagram showing a function configuration example of a remote issuance server 50 constituting a part of the information processing system 100.

As shown in FIG. 1, the information processing system 100 includes the application server 40 serving as an intermediate server, the remote issuance server 50 serving as a management server, the first terminal device 10 serving as an information processing device, the second terminal device 20 serving as communication equipment, and a communication network 30.

In the information processing system 100, the data of a first memory unit 1713 on which an electronic value retained by the first terminal device 10 is recorded and the data of a second memory unit 2713 on which an electronic value retained by the second terminal device 20 is recorded are configured to be rewritable on the basis of an execution instruction from the remote issuance server 50.

The first terminal device 10 and the second terminal device 20 are configured to be capable of performing near field communication each other using a reader/writer (R/W) 170 installed in the first terminal device 10. In the information processing system 100, the activation of the reader/writer 170 is instructed from the remote issuance server 50 when the first terminal device 10 requests the remote issuance server 50 to transfer an electronic value.

By the activation of the reader/writer 170, the first terminal device 10 is allowed to rewrite the second memory unit 2713 of the second terminal device 20 using near field communication on the basis of an instruction from the remote issuance server 50.

[Configuration of Communication Network]

The communication network 30 is a wireless or wired transmission path for information transmitted from the first terminal device 10, the application server 40, the remote issuance server 50, or the like connected to the communication network 30. For example, the communication network 30 may include a public line network such as the Internet, a telephone line network, and a satellite communication network.

[Configuration of First Terminal Device]

FIG. 2 is a block diagram showing a function configuration example of a first mobile terminal device (hereinafter simply called a first terminal device) 10 serving as an information processing device.

The first terminal device 10 is a terminal connectable to the communication network 30. The first terminal device 10 may be a mobile phone such as a smartphone, a tablet terminal, or the like and is typically a smartphone. In the present embodiment, a smartphone allowing a touch panel operation will be described as an example.

As shown in FIG. 2, the first terminal device 10 includes a communication unit 121, a display unit 122, an input unit 124, a program storage unit 128, a first control unit 126, the reader/writer (R/W) 170, a first IC (Integrated Circuit) chip 171, and a first communication antenna 172.

The communication unit 121 performs communication with other devices such as the application server 40 and the remote issuance server 50 via, for example, a wireless network.

The display unit 122 displays information received by the communication unit 121, information corresponding to an operation performed by a user on the input unit 124, or the like. The display unit 122 includes, for example, an image display panel such as a liquid crystal display and an organic EL display. Further, the display unit 122 may be provided with a touch panel.

The input unit 124 includes keys, buttons, a touch panel, a microphone, or the like.

The program storage unit 128 stores an electronic money transfer application program 1281 for executing an electronic money transfer service between the first terminal device 10 and the second terminal device 20. The application program 1281 is an application program corresponding to a terminal device in which an IC chip (the first IC chip 171 of the first terminal device 10 in the present embodiment) remotely controllable by the remote issuance server 50 is installed.

The application program (simply also called an application) 1281 causes the display unit 122 to display a user interface related to the transfer of an electronic value. Through the interface displayed on the display unit 122, the activation of an application, the operation of inputting transfer information regarding an electronic value, and the transfer of an electronic value are executed by a user.

The first control unit 126 controls the operation of the first terminal device 10. The first control unit 126 controls, by executing the application program 1281 stored in the program storage unit 128, the operation of the first terminal device 10 on the basis of the operation of an application program.

The control of the operation of the first terminal device 10 by the first control unit 126 accompanied by the execution of the application program 1281 includes: a request to transfer electronic money to the application server 40; the activation of the reader/writer 170 based on a reader/writer activation instruction from the remote issuance server 50; a request to execute the transfer of electronic money to the application server 40; the subtraction processing of electronic money and the rewriting of the first memory unit based on a subtraction processing instruction from the remote issuance server 50; and the execution of transmission of an instruction of the addition processing of electronic money and the rewriting of the second memory unit based on an instruction from the remote issuance server 50 to the second terminal device 20; or the like.

The first terminal device 10 has a reader/writer function by the installation of the reader/writer 170. Further, the first terminal device 10 has a non-contact IC card function by the installation of the first communication antenna 172 and the first IC chip 171.

The first terminal device 10 is allowed to perform, using the reader/writer function, the rewriting of data stored in an external non-contact IC card, or the like. Further, the first terminal device 10 is allowed to cause an external reader/writer to read prescribed data from the first terminal device 10 by the non-contact IC card function.

The reader/writer 170 is configured to be capable of supplying electromagnetic waves to the second terminal device 20. The reader/writer 170 generates prescribed electromagnetic waves, and then a second communication antenna 272 of the second terminal device 20 that will be described later generates an electromotive force in response to the electromagnetic waves. The second IC chip 271 operates with the electromotive force as a power source.

Thus, the first terminal device 10 and the second terminal device 20 are allowed to perform near field communication each other, and the first terminal device 10 is allowed to rewrite the data of the second memory unit 2713 of the second terminal device 20.

The reader/writer 170 includes a reader/writer (R/W) antenna 1701, a reader/writer transmission circuit 1702, and a reader/writer reception circuit 1703.

The reader/writer transmission circuit 1702 modulates a transmission carrier signal of a prescribed frequency according to data to be transmitted to an external non-contact IC card (for example, a non-contact IC card including the second communication antenna 272 and the second IC chip 271 of the second terminal device 20), and transmits the modulated signal to the external non-contact IC card via the reader/writer antenna 1701.

The reader/writer reception circuit 1703 receives a response signal transmitted from an external non-contact IC card and modulates the data to acquire reception data.

The first communication antenna 172 receives electromagnetic waves transmitted from an external wireless reader/writer not shown. The first communication antenna 172 having received the electromagnetic waves generates an electromotive force. The first IC chip 171 operates with the electromotive force as a power source.

The first IC chip 171 has an individual identification number 1711 for identifying itself. The individual identification number 1711 is a unique ID number that is recorded on the IC chip at the manufacturing of the IC chip and not rewritable. The first IC chip 171 is configured to be operable by the power source of the first terminal device 10 other than being operable by an electromotive force generated by the first communication antenna 172.

The first IC chip 171 includes a first IC control unit 1712, the first memory unit 1713, a first authentication unit 1714, and a first encryption processing unit 1715.

The first memory unit 1713 is divided into a free region and a common region. The common region is a region managed by a business operator who operates and manages the remote issuance server 50.

The common region of the first memory unit 1713 is further divided into a plurality of regions called areas, and the areas are allocated for each service.

In the common region of the first memory unit 1713, the data of an electronic value retained by the first terminal device 10 is stored. The data of an electronic value refers to information having a prescribed value such as a money value and is, for example, secure data such as electronic money, point information, and coupon information (or coupon balance information). In the present embodiment, electronic money serving as an electronic value will be described as an example.

In the present embodiment, the first terminal device 10 is configured to be capable of retaining, for example, four types of electronic money, electronic money A, electronic money B, electronic money C, and electronic money D. The first memory unit 1713 is configured to be capable of recording the services of a plurality of such electronic money and data related to an electronic money transfer service. Data inside the first memory unit 1713 will be read/written by the first IC control unit 1712 on the basis of an instruction from the remote issuance server 50.

The first authentication unit 1714 authenticates, during the mutual authentication between the first terminal device 10 and the second terminal device 20, whether a random number generated by the first terminal device 10 is transmitted to the second terminal device 20 and matches a random number transmitted to the first terminal device 10.

The first encryption processing unit 1715 encrypts a random number by a key (key (authentication key) used for authentication) prepared in advance.

[Configuration of Second Terminal Device]

FIG. 3 is a block diagram showing a function configuration example of a second mobile terminal device (hereinafter simply called a second terminal device) serving as communication equipment.

The second terminal device 20 serving as communication equipment is a terminal capable of performing near field communication with the first terminal device 10 using electromagnetic waves. The second terminal device 20 may be, for example, a mobile phone such as a smartphone, a tablet terminal, or the like, or may be an electronic money card capable of retaining electronic money.

The communication equipment only has to be capable of performing near field communication with the first terminal device 10 using at least the reader/writer 170 of the first terminal device 10 and capable of retaining electronic money. The second terminal device 20 is typically a smartphone, and a smartphone allowing a touch panel operation will be described as an example in the present embodiment.

As shown in FIG. 3, the second terminal device 20 has a communication unit 221, a display unit 222, an input unit 224, a second control unit 226, the second IC chip 271, and the second communication antenna 272 serving as a near field communication unit.

The communication unit 221 performs communication with other devices via, for example, a wireless network.

The input unit 224 includes keys, buttons, a touch panel, a microphone, or the like.

The display unit 222 displays information received by the communication unit 221, information corresponding to an operation performed by a user on the input unit 224, or the like. The display unit 222 includes, for example, an image display panel such as a liquid crystal display and an organic EL display. Further, the display unit 222 may be provided with a touch panel.

The second control unit 226 controls the operation of the second terminal device 20.

The second communication antenna 272 performs non-contact near field communication with the first terminal device 10 using electromagnetic waves. The second communication antenna 272 reacts with electromagnetic waves emitted from the reader/writer 170 and generates an electromotive force. The second IC chip 271 operates with the electromotive force as a power source.

The second IC chip 271 has an individual identification number 2711 for identifying itself. The second IC chip 271 includes a second IC control unit 2712, the second memory unit 2713, a second authentication unit 2714, and a second encryption processing unit 2715.

The second memory unit 2713 is divided into a free region and a common region. The common region is a region managed by a business operator who operates and manages the remote issuance server 50.

The common region of the second memory unit 2713 is further divided into a plurality of regions called areas, and the areas are allocated for each service.

In the common region of the second memory unit 2713, the data of an electronic value retained by the second terminal device 20 is stored like the first memory unit 1713. In the present embodiment, the second terminal device 20 is configured to be capable of retaining, for example, two types of electronic money, the electronic money A and the electronic money C.

The second memory unit 2713 is configured to be capable of recording the services of a plurality of such electronic money and data related to an electronic money transfer service. Data inside the second memory unit 2713 will be read/written by the second IC control unit 2712 on the basis of an instruction from the remote issuance server 50. The instruction from the remote issuance server 50 is transmitted to the second terminal device 20 via the reader/writer 170 of the first terminal device 10.

The second authentication unit 2714 authenticates, during the mutual authentication between the first terminal device 10 and the second terminal device 20, whether a random number generated by the second terminal device 20 is transmitted to the first terminal device 10 and matches a random number transmitted to the second terminal device 20.

The second encryption processing unit 2715 encrypts a random number by a key (key (authentication key) used for authentication) prepared in advance.

The first terminal device 10 is allowed to perform, by the activation of the reader/writer 170 accompanied by the execution of the electronic money transfer application program 1281, near field communication with the second terminal device 20 and provide an instruction to rewrite the data of the second memory unit 2713 of the second terminal device 20.

In order to allow the first terminal device 10 to rewrite the data of the second memory unit 2713, the authentication of access to the second terminal device 20 by the first terminal device 10 becomes necessary.

In addition, the mutual authentication between the first terminal device 10 and the second terminal device 20 is performed after the access is authenticated. After the access authentication and the mutual authentication are normally performed, the transfer of electronic money between the first terminal device 10 and the second terminal device 20 using the reader/writer 170 of the first terminal device 10 is allowed. Hereinafter, the access authentication and the mutual authentication will be described.

First, the access authentication will be described. FIG. 5 is a diagram for describing the outline of the information processing system.

The first terminal device 10 acquires, by the activation of the reader/writer 170, the individual identification number 2711 of the second IC chip 271 of the second terminal device 20 via the reader/writer 170. The first control unit 126 of the first terminal device 10 transmits the second individual identification number 2711 to the application server 40 together with the first individual identification number 1711 of the first IC chip 171.

The application server 40 requests the remote issuance server 50 to confirm whether the first terminal device 10 and the second terminal device 20 are the authorized users of the remote issuance server 50 on the basis of the first individual identification number 1711 and the second individual identification number 2711.

The remote issuance server 50 confirms, by referring to a database (DB) 54, whether the first individual identification number 1711 and the second individual identification number 2711 exist in the database 54. When the respective individual identification numbers exist in the database 54, the remote issuance server 50 determines that the first terminal device 10 and the second terminal device 20 are the authorized users.

The remote issuance server 50 transmits a confirmation result that the first terminal device 10 and the second terminal device 20 are the authorized users to the application server 40, and the application server 40 notifies the first terminal device 10 of the fact that access to the second terminal device 20 by the first terminal device 10 has been authenticated.

Next, the mutual authentication will be described.

After the end of the access authentication, the mutual authentication between the first terminal device 10 and the second terminal device 20 is performed. The flow of the mutual authentication will be described below.

The same key is prepared in advance in the first IC chip 171 and the second IC chip 271. The first IC chip 171 has a key capable of decrypting information encrypted by the second IC chip 271. The second IC chip 271 has a key capable of decrypting information encrypted by the first IC chip 171.

When being notified of the above access authentication, the first control unit 126 requests the reader/writer 170 to perform the mutual authentication between the first IC chip 171 serving as the transfer source of electronic money data and the second IC chip 271 serving as the transfer destination of the electronic money data.

In response to the request, a prescribed random number (random number A) is generated in the first IC chip 171. The generated random number A is encrypted using the key (key used for authentication (authentication key)) prepared in advance by the first encryption processing unit 1715 and transmitted to the reader/writer 170. The reader/writer 170 transmits the encrypted random number A to the second IC chip 271.

In the second IC chip 271, decryption is performed using the authentication key prepared in advance to acquire the random number A generated by the first IC chip 171. The acquired random number A is stored in the second IC chip 271.

Further, in the second IC chip 271 as well, a prescribed random number (random number B) is generated. The random number B generated here and the random number A acquired by the decryption are encrypted using the authentication key by the second encryption processing unit 2715 and transmitted to the reader/writer 170. The reader/writer 170 transmits the encrypted random number A and the random number B to the first IC chip 171.

In the first IC chip 171 having received the data transmitted from the second IC chip 271, decryption is performed using the authentication key to acquire the random number B generated by the second IC chip 271 and the random number A encrypted by the second IC chip 271.

When it is confirmed by the first authentication unit 1714 that the acquired random number A is the same as the random number A generated by the first IC chip 171 itself, the random number B acquired by the decryption is stored in the first IC chip 171.

Further, at this time, the random number B is encrypted using the authentication key by the first encryption processing unit 1715 and transmitted to the reader/writer 170 in the first IC chip 171. The reader/writer 170 transmits the encrypted random number B to the second IC chip 271.

In the second IC chip 271, decryption is performed using the authentication key to acquire the random number B having been encrypted by the first IC chip 171. When it is confirmed by the second authentication unit 2714 that the acquired random number B is the same as the random number B generated by the second IC chip 271 itself, it is determined that the mutual authentication has been normally performed. Thus, a series of the mutual authentication processing is ended.

[Configuration of Application Server]

The application server 40 serving as an intermediate server is a server operated by a business operator who offers an electronic money transfer service that makes it possible to exchange electronic money of a certain type for electronic money different from the certain type and transfer the exchanged electronic money between terminal devices. The business operator of the electronic money transfer service is allowed to offer the electronic money transfer service by making an application for use to a business operator who operates and manages the remote issuance server 50.

The application server 40 exchanges information with the remote issuance server 50 and the first terminal device 10 where necessary.

FIG. 4 is a block diagram showing a function configuration example of the application server 40.

As shown in FIG. 4, the application server 40 includes a communication unit 41, an information acquisition unit 42, and a processing execution unit 43.

The communication unit 41 performs communication with the first terminal device 10 or the remote issuance server 50 to transmit/receive information.

The information acquisition unit 42 acquires information acquired by the communication unit 41 through communication with the first terminal device 10. Information acquired by the information acquisition unit 42 is offered to the processing execution unit 43.

The processing execution unit 43 executes various processing based on information acquired by the information acquisition unit 42. For example, when receiving a request to transfer electronic money from the first terminal device 10, the processing execution unit 43 requests the remote issuance server 50 to activate the reader/writer 170.

When receiving a request to execute the transfer of electronic money from the first terminal device 10, the processing execution unit 43 requests the remote issuance server 50 to delete first electronic money corresponding to an amount of the transfer from the first memory unit 1713 of the first terminal device 10.

In addition, when receiving a request to execute the transfer of electronic money from the first terminal device 10, the processing execution unit 43 requests the remote issuance server 50 to add second electronic money corresponding to an amount of the transfer to the second memory unit 2713 of the second terminal device 20.

[Configuration of Remote Issuance Server]

The remote issuance server 50 serving as a management server executes processing based on an instruction provided by the application server 40 on the basis of information transmitted from the first terminal device 10.

An electronic money service using the first IC chip 171 and the second IC chip 271 is offered using the common regions of the respective IC chips 171 and 271, and the common regions are operated and managed by the remote issuance server 50.

The remote issuance server 50 performs management to prevent, for example, the data items of the respective electronic money service business operators of electronic money A, electronic money B, electronic money C, and electronic money D using the common regions inside the IC chips from overlapping each other. For example, the remote issuance server 50 divides memory units inside the common regions into areas and allocates the divided memory units to the respective service business operators.

FIG. 5 is a block diagram showing a function configuration example of the remote issuance server 50.

As shown in FIG. 5, the remote issuance server 50 includes a communication unit 51, an information acquisition unit 52, and a processing execution unit 53.

The communication unit 51 performs communication with the first terminal device 10 or the application server 40 to transmit/receive information.

The information acquisition unit 52 acquires information acquired by the communication unit 51 through communication with the application server 40. Information acquired by the information acquisition unit 52 is offered to the processing execution unit 53.

The processing execution unit 53 executes various processing based on information acquired by the information acquisition unit 52. Various processing executed by the processing execution unit 53 is performed on the basis of electronic money transfer information input to the first terminal device 10.

For example, when receiving a request to activate the reader/writer 170 from the application server 40, the processing execution unit 53 instructs the first terminal device 10 to activate the reader/writer 170.

When receiving a request to delete first electronic money corresponding to an amount of transfer from the first memory unit 1713 of the first terminal device 10 from the application server 40, the processing execution unit 53 transmits an instruction to delete the first electronic money corresponding to the amount of the transfer from the first memory unit 1713 to the first terminal device 10.

In addition, when receiving a request to add second electronic money corresponding to an amount of to transfer to the second memory unit 2713 of the second terminal device 20 from the application server 40, the processing execution unit 53 transmits an instruction to add the second electronic money corresponding to the amount of the transfer to the second memory unit 2713 to the first terminal device 10.

<Description of Operation of Information Processing System>

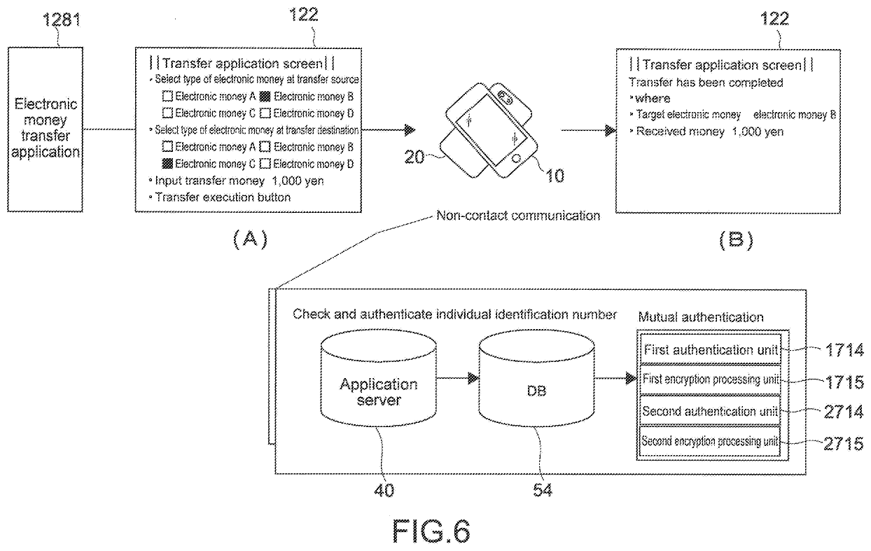

Next, the operation of the above information processing system 100 will be described using FIGS. 6(A) and 6(B) to FIG. 8. Here, an example will be described in which the electronic money B serving as first electronic money retained by the first terminal device 10 is converted into the electronic money C serving as second electronic money of a type different from the first electronic money and transferred to the second terminal device 20.

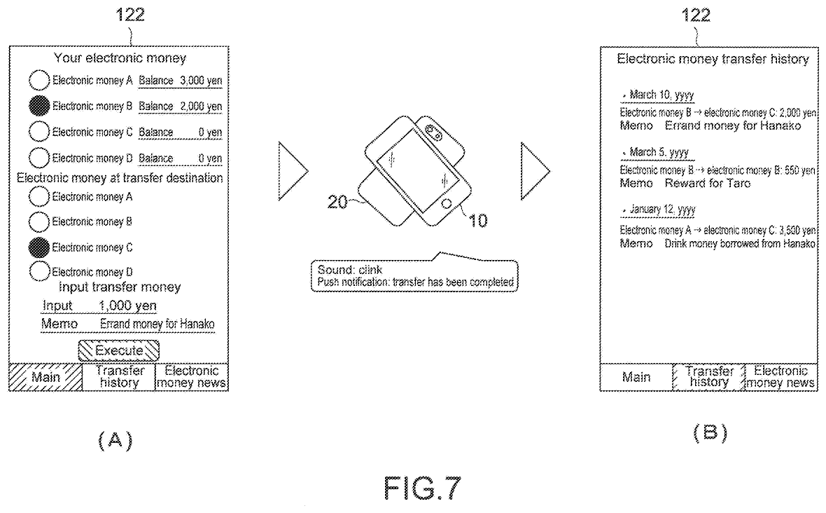

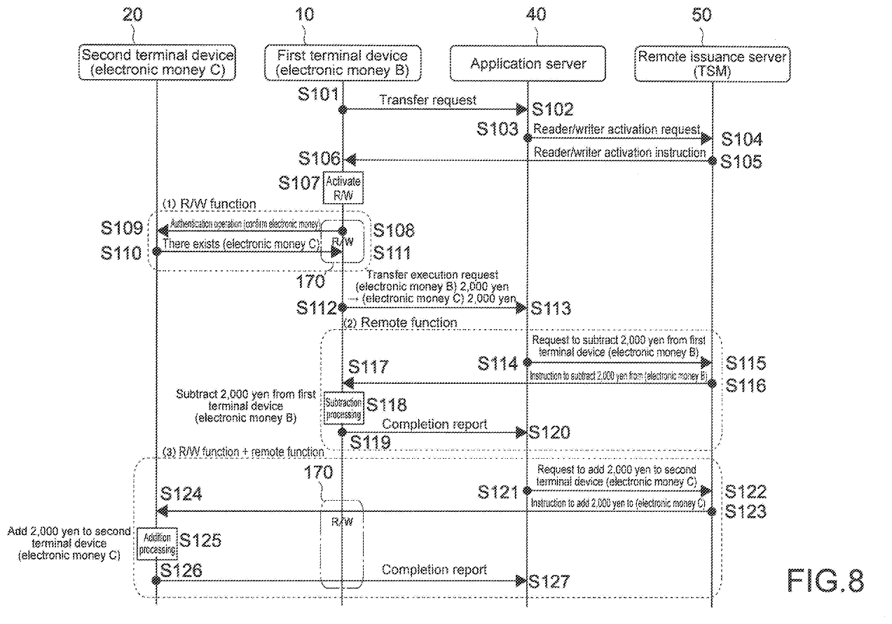

FIGS. 6(A) and 6(B) and FIGS. 7(A) and 7(B) are diagrams for describing the outline of the information processing system. FIG. 8 is a sequence diagram showing an operation example of the respective devices constituting the information processing system 100. Hereinafter, the outline will be described according to FIG. 8.

First, the execution of an electronic money transfer service is allowed when the electronic money transfer application program 1281 is downloaded in the first terminal device 10 by a user.

By the execution of the electronic money transfer application program 1281, a screen for inputting electronic money transfer information is displayed on the display unit 122 of the first terminal device 10 as shown in, for example, FIG. 6(A) or FIG. 7(A).

On the display unit 122, a check column for selecting any type of electronic money to be transferred from among electronic money retained by the first terminal device 10 serving as a transfer source, a check column for selecting any type of electronic money into which the electronic money retained by the first terminal device 10 is converted and which is transferred to the second terminal device 20 serving as a transfer destination, a transfer money input column, and a transfer execution button are displayed. In an example shown in FIG. 7(A), a memo column is further displayed.

By the user of the first terminal device 10, any type of electronic money to be transferred is selected and checked from among the electronic money retained by the first terminal device 10. For example, in FIG. 6(A) and FIG. 7(A), the electronic money B is selected and checked as the electronic money of the transfer source.

Next, any type of electronic money into which the electric money to be transferred is converted and which is transferred to the second terminal device 20 is selected and checked. For example, in FIG. 6(A) and FIG. 7(A), the electronic money C is selected and checked as the electronic money of the transfer destination.

In addition, transfer money, for example, 1,000 yen is input to the transfer money input column, a memo such as the purpose of the transfer is arbitrarily input to the memo column, and the transfer execution button is tapped by the user. Thus, the first control unit 126 causes the communication unit 121 to transmit a request to transfer the transfer information and the electronic money to the application server 40 (S101).

When receiving the request to transfer the electronic money from the first terminal device 10 (S102), the application server 40 transmits a request to activate the reader/writer 170 to the remote issuance server 50 (S103).

When receiving the request to activate the reader/writer 170 from the application server 40 (S104), the remote issuance server 50 transmits an instruction to activate the reader/writer 170 to the first terminal device 10 (S105).

When the communication unit 121 of the first terminal device 10 receives the instruction to activate the reader/writer 170 (S106), the first control unit 126 activates the reader/writer 170 (S107). When the reader/writer 170 activates, an instruction to make the first terminal device 10 and the second terminal device 20 get close to each other is displayed on the display unit 122.

When the reader/writer 170 activates and the first terminal device 10 and the second terminal device 20 get close to each other, non-contact near field communication is established between the first terminal device 10 and the second terminal device 20 by electromagnetic waves.

After the near field communication is established, the above access authentication and the mutual authentication are performed. When the access authentication and the mutual authentication are normally performed, the transfer of the electronic money using the reader/writer 170 of the first terminal device 10 is allowed.

When the access authentication and the mutual authentication are normally performed, the first IC control unit 1712 causes the reader/writer 170 to transmit a confirmation request to confirm whether the type of the electronic money of the transfer destination having been input by the user of the first terminal device 10 is electronic money retainable by the second terminal device 20 to the second terminal device 20 (S108).

When the second terminal device 20 receives the request to confirm the type of the electronic money (S109), the second IC control unit 2712 confirms whether the type of the electronic money having been input by the user of the first terminal device 10 is the type of electronic money (the electronic money C in the present embodiment) receivable by the second terminal device 20 that is the transfer destination having been input by the user.

When confirming that the type of the electronic money having been input by the user of the first terminal device 10 is the electronic money of a retainable type, the second IC control unit 2712 transmits, to the first terminal device 10, a notification that the type of the electronic money having been input by the user exists (S110). As described above, electronic money is confirmed by the first terminal device 10 using the reader/writer function.

Note here that when the type of the electronic money having been input by the user is not retainable by the second terminal device 20, the second terminal device 20 notifies the first terminal device 10 of the fact. Further, the information regarding the type of electronic money retainable by the second terminal device 20 is transmitted to the first terminal device 10 together with the notification.

When receiving the notification, the first terminal device 10 displays a notification screen for the information regarding the type of the electronic money retainable by the second terminal device 20 and further displays the input screen shown in FIG. 7(A) again.

When receiving a confirmation result that the type of the electronic money having been input by the user is retainable by the second terminal device 20 (S111), the first terminal device 10 transmits a request to execute the transfer of the electronic money to the application server 40 on the basis of the electronic money transfer information having been input by the user (S112).

In the present embodiment, the transfer of the electronic money is to convert the electronic money B recorded on the first memory unit 1713 into the electronic money C and transfer the converted electronic money C to the second memory unit 2713.

When receiving the request to execute the transfer of the electronic money (S113), the application server 40 transmits a request to delete, i.e., subtract money corresponding to an amount of the transfer from the electronic money B retained by the first terminal device 10 to the remote issuance server 50 (S114).

The remote issuance server 50 receives the subtraction request (S115) and transmits an instruction to execute subtraction processing to subtract the money corresponding to the amount of the transfer from the first memory unit 1713 to the first terminal device 10 (S116). Note that since an electronic value is electronic money in the present embodiment, deletion processing to delete the electronic value and addition processing to add the electronic value will be called subtraction processing and addition processing, respectively.

When receiving the instruction to execute the subtraction processing (S117) in the first terminal device 10, the first control unit 126 causes the first IC control unit 1712 to perform the subtraction processing to subtract 1,000 yen corresponding to the amount of the transfer from the retained electronic money B (S118) and rewrite the data of the electronic money B stored in the first memory unit 1713.

Thus, the first IC chip 171 of the first terminal device 10 is remotely controlled by the remote issuance server 50 (remote function).

When the subtraction processing ends, the first terminal device 10 transmits a report on the completion of the subtraction processing to the application server 40 (S119). The application server 40 receives the completion report (S120).

Next, the application server 40 transmits a request to add 1,000 yen corresponding to the amount of the transfer to the electronic money C retained by the second terminal device 20, i.e., an addition request to the remote issuance server 50 (S121).

The remote issuance server 50 receives the addition request (S122) and instructs the first terminal device 10 to execute addition processing to add the money corresponding to the amount of the transfer to the second memory unit 2713 (S123). The first control unit 126 of the first terminal device 10 causes, on the basis of the instruction from the remote issuance server 50, the reader/writer 170 to transmit an instruction to execute the addition processing to the second terminal device 20.

When receiving the instruction to execute the addition processing in the second terminal device 20 (S124), the second IC control unit 2712 performs the addition processing to add 1,000 yen corresponding to the amount of the transfer to the retained electronic money C (S125) and rewrites the data of the electronic money C to be stored in the second memory unit 2713.

Thus, the second IC chip 271 of the second terminal device 20 is remotely controlled (reader/writer function, remote function) by the remote issuance server 50 via the reader/writer 170 of the first terminal device 10.

When the addition processing ends, the second terminal device 20 transmits a report on the completion of the addition processing to the application server 40 via the reader/writer 170 of the first terminal device 10 (S126). The application server 40 receives the completion report (S127). In the manner described above, the electronic money retained by the first terminal device 10 is converted into the different type and transferred to the second terminal device 20.

When the transfer is completed, the sound “the transfer has been completed” is emitted from the first terminal device 10 in succession to, for example, an electronic sound such as “clink.” Further, when the transfer is completed, transfer content as shown in, for example, FIG. 6(B) is displayed on the display unit 122 of the first terminal device 10.

Further, when a transfer history button is tapped in FIG. 7(A), a date, transfer content, and a memo are displayed as transfer histories as shown in FIG. 7(B).

In the present embodiment, an electronic value is allowed to be easily transferred between individuals by performing near field communication with the first terminal device serving as the transfer source of the electronic value held over the second terminal device serving as the transfer destination of the electronic value as described above.

In the present embodiment, the transfer of an electronic value is not allowed if the first terminal device (information processing device) serving as the transfer source of the electronic value and the second terminal device (communication equipment) serving as the transfer destination of the electronic value do not exist in the same place. Therefore, physical restrictions are imposed.

Accordingly, the user of the first terminal device and the user of the second terminal device exist in the same place, and the user of the first terminal device serving as the transfer source of an electronic value and the user of the second terminal device serving as the transfer destination of the electronic value exchange the electronic value with each other by mutual agreement. Thus, the users are allowed to transfer an electronic value with a feeling as if they directly transferred actual money or actual goods.

In the present embodiment, the second terminal device that receives an electronic value does not have to download an application but only has to perform near field communication using the reader/writer of the first terminal device to be allowed to receive the electronic value.

Further, the transfer destination of an electronic value is definitely specified when seen from the first terminal device since the first terminal device serving as the transfer source of the electronic value and the second terminal device serving as the transfer destination of the electronic value exist in the same place, and thus the second terminal device 20 does not have to directly access the application server 40 and the remote issuance server 50.

Since the second terminal device is allowed to receive an electronic value without the input of any personal information or information such as account information, the trouble of inputting information is saved. As a result, it becomes possible to easily transfer an electronic value.

Further, in the present embodiment, an electronic value is allowed to be transferred after being converted into a different type regardless of the type of an electronic value retainable by each of a transfer source and a transfer destination. Therefore, usability is excellent.

In the present embodiment, electronic money serving as an electronic value is described as an example. However, the present technology is not limited to this but is also applicable to an electronic value such as an electronic ticket and a coupon. Hereinafter, an example in which a ticket serving as an electronic value is transferred will be described as a second embodiment, and a case in which an electronic ticket is exchanged for electronic money will be described.

### Second Embodiment

<Configuration of Information Processing System>

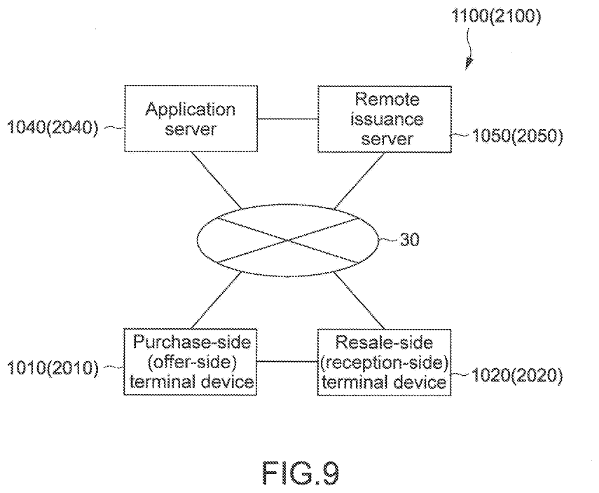

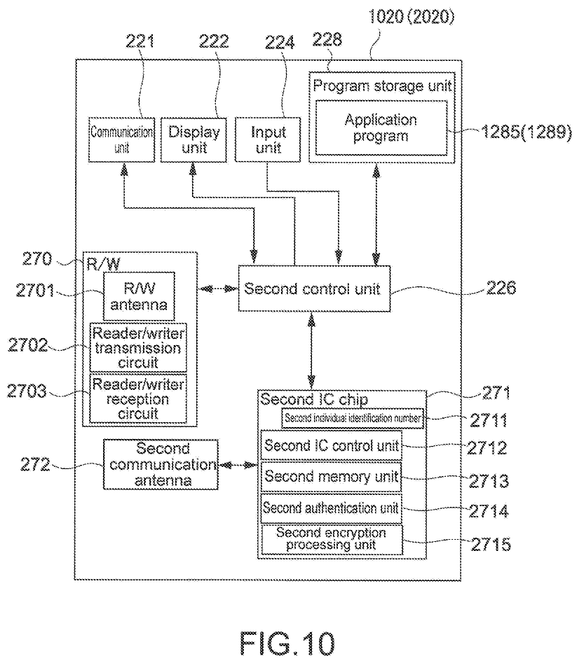

FIG. 9 shows a configuration example of an information processing system according to the present embodiment. FIG. 10 is a block diagram showing a function configuration example of a purchase-side terminal device constituting a part of the information processing system shown in FIG. 9.

As shown in FIG. 9, an information processing system 1100 includes an application server 1040 serving as an intermediate server, a remote issuance server 1050 serving as a management server, a purchase-side terminal device 1010 serving as an information processing device, a resale-side terminal device 1020 serving as communication equipment, and a communication network 30. The same configurations as those of the first embodiment will be denoted by the same signs, and differences will be mainly described.

An information processing system 100 is configured such that, when the purchase-side terminal device 1010 and the resale-side terminal device 1020 perform near field communication using electromagnetic waves, each of electronic money and an electronic ticket serving as electronic values is transferred between the purchase-side terminal device 1010 and the resale-side terminal device 1020 to allow the exchange of the electronic money and the electronic ticket.

The purchase-side terminal device 1010 and the resale-side terminal device 1020 are terminals connectable to the communication network 30. The purchase-side terminal device 1010 and the resale-side terminal device 1020 may be, for example, mobile phones such as smartphones, tablet terminals, or the like and are typically smartphones. In the present embodiment, an example of smartphones allowing a touch panel operation will be described.

The purchase-side terminal device 1010 is a side that purchases an electronic ticket retained by the resale-side terminal device 1020. The resale-side terminal device 1020 is a side that sells an electronic ticket retained by the resale-side terminal device 1020 itself to the purchase-side terminal device 1010.

The user of the resale-side terminal device 1020 is not an electronic ticket dealer but is a person who purchases, for example, the electronic ticket of a concert from an electronic ticket dealer but resales the electronic ticket to the user of the purchase-side terminal device 1010 since he/she becomes unable to go to the concert later.

The user of the resale-side terminal device 1020 and the user of the purchase-side terminal device 1010 are allowed to trade an electronic ticket between individuals by using an electronic money and electronic ticket transfer service application.

FIG. 2 is a block diagram showing a function configuration example of the purchase-side terminal device 1010. As shown in FIG. 2, the purchase-side terminal device 1010 includes almost the same configurations as those of the above first terminal device 10.

In the purchase-side terminal device 1010, an application program stored in a program storage unit 128 is an electronic money and electronic ticket transfer service application program 1285.

The application program 1285 is an application program corresponding to a terminal device in which an IC chip remotely controllable by the remote issuance server 1050 is installed. The application program 1285 is offered by an electronic ticket dealer. Using the application, the services of the purchase of an electronic ticket, the transfer of an electronic ticket, and the transfer of electronic money are available.

A first control unit 126 of the purchase-side terminal device 1010 controls the operation of the purchase-side terminal device 1010. The first control unit 126 controls, by executing the application program 1285 stored in the program storage unit 128, the operation of the purchase-side terminal device 1010.

The control of the operation of the purchase-side terminal device 1010 by the first control unit 126 accompanied by the execution of the application program 1285 includes: a request to transfer electronic money and an electronic ticket to the application server 1040; the activation of a reader/writer 170 based on a reader/writer activation instruction from the remote issuance server 1050; a request to execute the transfer of electronic money and an electronic ticket; the writing of an electronic ticket and the rewriting of a first memory unit 1713 accompanied by the subtraction processing of electronic money based on an instruction from the remote issuance server 1050; and the execution of transmission of an instruction to delete an electronic ticket and rewrite the second memory unit 2713 of the resale-side terminal device 1020 accompanied by the addition processing of an electronic money based on an instruction from the remote issuance server 50 to the resale-side terminal device 1020; or the like.

The purchase-side terminal device 1010 is configured to be capable of retaining, for example, four types of electronic money, electronic money A, electronic money B, electronic money C, and electronic money D and an electronic ticket. The first memory unit 1713 of the purchase-side terminal device 1010 is configured to be capable of recording the services of a plurality of such electronic money and data related to an electronic money and electronic ticket transfer service.

FIG. 10 is a block diagram showing a function configuration example of the resale-side terminal device 1020. The resale-side terminal device 1020 includes almost the same configurations as those of the above first terminal device 10 and has a configuration in which a reader/writer 270 and a program storage unit 228 are added to the configurations of the above second terminal device 20. The same configurations as those of the second terminal device 20 will be denoted by the same signs.

In the program storage unit 228 of the resale-side terminal device 1020, the same electronic money and electronic ticket transfer service application program 1285 as that of the purchase-side terminal device 1010 is stored.

The reader/writer 270 includes a reader/writer (R/W) antenna 2701, a reader/writer transmission circuit 2702, and a reader/writer reception circuit 2703, and the respective configurations have the same functions as those of the reader/writer 170 of the above first terminal device 10.

The resale-side terminal device 1020 is configured to be capable of retaining, for example, two types of electronic money, the electronic money A and the electronic money C and an electronic ticket. The second memory unit 2713 of the resale-side terminal device 1020 is configured to be capable of recording the services of a plurality of such electronic money and data related to an electronic money and electronic ticket transfer service.

In the present embodiment, the purchase-side terminal device 1010 rewrites data stored in the second memory unit 2713 constituted of a second IC chip 271 and having a non-contact IC card function through a second communication antenna 272 of the resale-side terminal device 1020 using the reader/writer function of the purchase-side terminal device 1010 itself.

The application server 1040 is a server operated by a business operator who offers an electronic money and electronic ticket transfer service that sells an electronic ticket, makes it possible to exchange electronic money of a certain type for electronic money of a different type to be capable of being transferred between different terminal devices, and further makes it possible to transfer an electronic ticket between different terminal devices.

As shown in FIG. 4, the application server 1040 includes the same configurations as those of the above application server 40.

A processing execution unit 43 of the application server 140 executes various processing based on information acquired by an information acquisition unit 42. For example, when receiving a request to transfer electronic money and an electronic ticket from the purchase-side terminal device 1010, the processing execution unit 43 requests the remote issuance server 1050 to activate the reader/writer 170.

When receiving a request to execute the transfer of electronic money and an electronic ticket from the purchase-side terminal device 1010, the processing execution unit 43 requests the remote issuance server 1050 to delete first electronic money corresponding to an amount of the transfer from the first memory unit 1713 of the purchase-side terminal device 1010 and add the electronic ticket to the first memory unit 1713.

In addition, when receiving a request to execute the transfer of electronic money and an electronic ticket from the purchase-side terminal device 1010, the processing execution unit 43 requests the remote issuance server 50 to add second electronic money corresponding to an amount of the transfer to the second memory unit 2713 of the resale-side terminal device 1020 and delete the electronic ticket from the second memory unit 2713.

The application server 1040 exchanges information with the remote issuance server 1050 and the purchase-side terminal device 1010 where necessary.

The remote issuance server 1050 executes processing based on an instruction provided by the application server 1040 on the basis of information transmitted from the purchase-side terminal device 1010. As shown in FIG. 5, the remote issuance server 1050 includes the same configurations as those of the above remote issuance server 50.

A processing execution unit 53 executes various processing based on information acquired by an information acquisition unit 52. Various processing executed by the processing execution unit 53 is performed on the basis of electronic money and electronic ticket transfer information input by the purchase-side terminal device 1010.

For example, when receiving a request to activate the reader/writer 170 from the application server 1040, the processing execution unit 53 instructs the purchase-side terminal device 1010 to activate the reader/writer 170.

When receiving a request to delete first electronic money corresponding to an amount of transfer from the first memory unit 1713 of the purchase-side terminal device 1010 and add an electronic ticket to the first memory unit 1713 from the application server 1040, the processing execution unit 53 transmits an instruction to delete the first electronic money corresponding to the amount of the transfer from the first memory unit 1713 and add the electronic ticket to the first memory unit 1713 to the purchase-side terminal device 1010.

In addition, when receiving a request to add second electronic money corresponding to an amount of transfer to the second memory unit 2713 of the resale-side terminal device 1020 and delete an electronic ticket from the second memory unit 2713 from the application server 1040, the processing execution unit 53 transmits an instruction to add the second electronic money corresponding to the amount of the transfer to the second memory unit 2713 and delete the electronic ticket from the second memory unit 2713 to the first terminal device 10.

The business operator of the electronic money and electronic ticket transfer service is allowed to offer the electronic money and electronic ticket transfer service by making an application for use to a business operator who operates and manages the remote issuance server 1050.

<Description of Operation of Information Processing System>

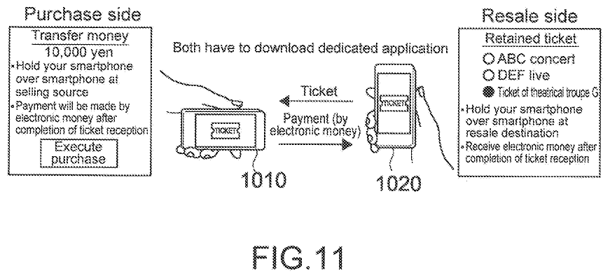

Next, the operation of the above information processing system 1100 will be described using FIG. 11 to FIG. 13. Here, an example will be described in which an electronic ticket retained by the resale-side terminal device 1020 is transferred to the purchase-side terminal device 1010 and the electronic money B serving as first electronic money retained by the purchase-side terminal device 1010 is converted into the electronic money C serving as second electronic money of a different type and transferred to the resale-side terminal device 1020 in exchange for the electronic ticket. In other words, different electronic values of an electronic ticket and electronic money are exchanged between individuals.

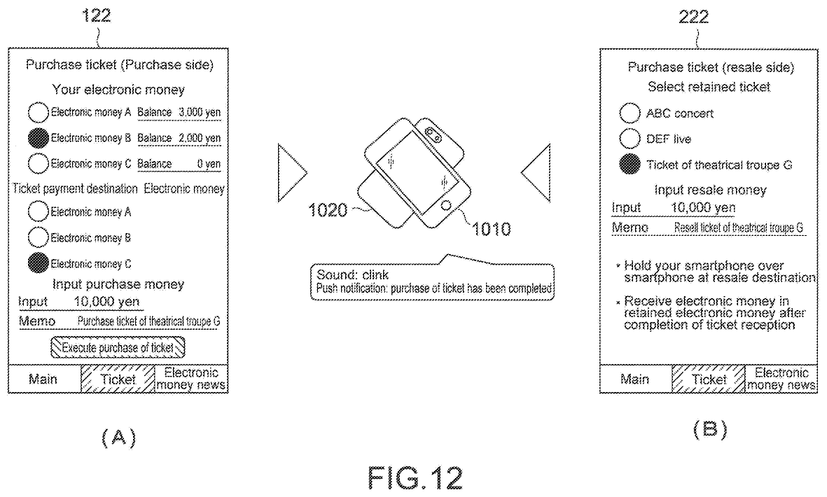

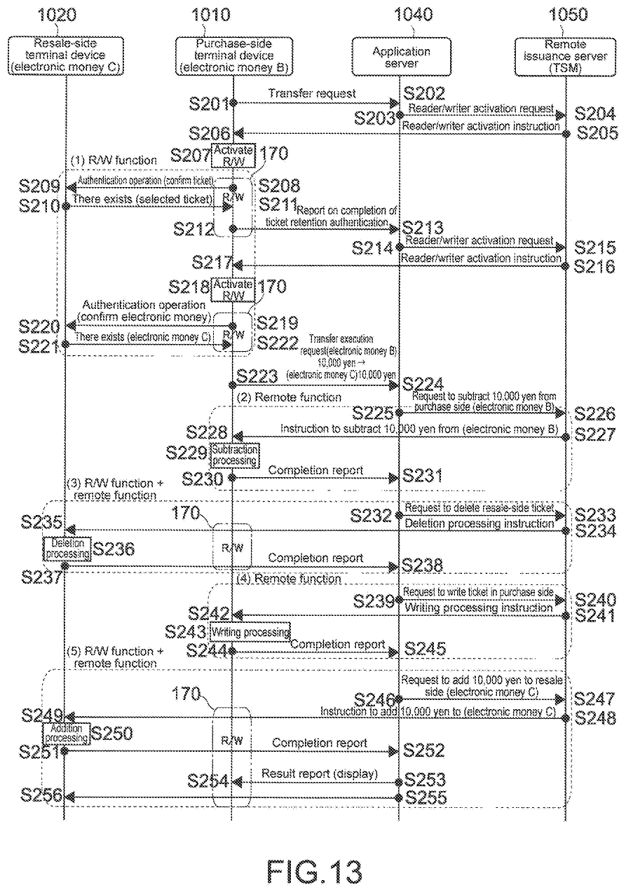

FIG. 11 and FIGS. 12(A) and 12(B) are diagrams for describing the outline of the information processing system 1100. FIG. 13 is a sequence diagram showing an operation example of the respective devices constituting the information processing system 1100. Hereinafter, the outline will be described according to FIG. 13.

First, the electronic money and electronic ticket transfer service application program 1285 is downloaded by users in both the purchase-side terminal device 1010 and the resale-side terminal device 1020. Thus, the execution of an electronic money and electronic ticket transfer service is allowed.

When the electronic money and electronic ticket transfer service application program 1285 is executed, a screen for inputting electronic money and electronic ticket transfer information is displayed on a display unit 122 of the purchase-side terminal device 1010 as shown in, for example, FIG. 12(A).

On the display unit 122, a check column for selecting any type of electronic money retained by the user of the purchase-side terminal device 1010 to make a payment, a check column for selecting any type of electronic money to make a payment to the user of the resale-side terminal device 1020, a purchase money input column, a memo column to which content of an electronic ticket to be purchased is input, and a ticket purchase execution button are displayed to purchase the electronic ticket.

By the user of the purchase-side terminal device 1010, the type of electronic money to be used to make a payment is selected from among electronic money retained by the purchase-side terminal device 1010, and any type of electronic money into which the electric money to be used to make a payment is converted and which is transferred, i.e., any type of electronic money to be used to make a payment is selected.

For example, in FIG. 12(A), the electronic money B is selected as the type of electronic money of a transfer source is selected, and the electronic money C is selected as the type of electronic money of a transfer destination. In addition, purchase money, for example, 10,000 yen is input to the purchase money input column. The name and purpose of a ticket to be purchased, for example, “purchase ticket of theatrical troupe G” is input to the memo column.

When the transfer information regarding electronic money and an electronic ticket is input by the user of the purchase-side terminal device 1010 and the ticket purchase button is tapped, the first control unit 126 causes the communication unit 121 to transmit the transfer information and a request to transfer the electronic money and the electronic ticket to the application server 1040 (S201).

When receiving the transfer request transmitted from the purchase-side terminal device 1010 (S202), the application server 1040 transmits a request to activate the reader/writer 170 to the remote issuance server 1050 (S203).

When receiving the reader/writer activation request transmitted from the application server 1040 (S204), the remote issuance server 1050 transmits an instruction to activate a reader/writer function to the purchase-side terminal device 1010 (S205).

When the communication unit 121 of the purchase-side terminal device 1010 receives the instruction to activate the reader/writer 170 (S206), the first control unit 126 causes the reader/writer 170 to activate (S207). When the reader/writer 170 activates, an instruction to make the purchase-side terminal device 1010 and the resale-side terminal device 1020 get close to each other is displayed on the display unit 122.

When the reader/writer 170 activates and the purchase-side terminal device 1010 and the resale-side terminal device 1020 get close to each other, non-contact near field communication is established between the purchase-side terminal device 1010 and the resale-side terminal device 1020 by electromagnetic waves.

After the near field communication is established, the above access authentication and the mutual authentication are performed. When the access authentication and the mutual authentication are normally performed, the transfer of the electronic money and the electronic ticket using the reader/writer 170 of the purchase-side terminal device 1010 is allowed.

When the access authentication and the mutual authentication are normally performed, transfer information such as a resale money column and a memo column is displayed on a display unit 222 of the resale-side terminal device 1020 as shown in, for example, FIG. 12(B). Here, 10,000 yen is displayed in the resale money column, and the name and purpose of a purchased ticket, for example, “resale of ticket of theatrical troupe G” is displayed in the memo column.

Next, a first IC control unit 1712 causes the reader/writer 170 to transmit a request to confirm whether the electronic ticket having been input by the user of the purchase-side terminal device 1010 is retained by the second terminal device 20 to the resale-side terminal device 1020 (S208).

When the resale-side terminal device 1020 receives the request to confirm the electronic ticket (S209), a second IC control unit 2712 confirms whether the electronic ticket as a purchase target, which has been input by the user of the purchase-side terminal device 1010, exists.

When confirming the existence of the electronic ticket, the second IC control unit 2712 transmits a notification indicating the existence of the electronic ticket to the first terminal device 10 (S210).

Note here that when the resale-side terminal device 1020 does not retain the electronic ticket having been input by the user of the purchase-side terminal device 1010, the purchase-side terminal device 1010 is notified of the fact. When receiving the notification, a notification screen indicating that “no target electronic ticket exists” is displayed in the purchase-side terminal device 1010.

When receiving the confirmation result that the target electronic ticket is retained (S211), the purchase-side terminal device 1010 transmits a report on the completion of the retention authentication of the electronic ticket to the application server 1040 (S212).

When receiving the report on the completion of the retention authentication of the electronic ticket (S213), the application server 1040 transmits a request to activate the reader/writer 170 to the remote issuance server 1050 (S214).

When receiving the request to activate the reader/writer 170 from the application server 1040 (S215), the remote issuance server 1050 transmits an instruction to activate the reader/writer 170 to the purchase-side terminal device 1010 (S216).

When the communication unit 121 of the purchase-side terminal device 1010 receives the instruction to activate the reader/writer 170 (S217), the first control unit 126 causes the reader/writer 170 to activate (S218). When the reader/writer 170 activates and the purchase-side terminal device 1010 and the resale-side terminal device 1020 get close to each other, non-contact near field communication is established between the purchase-side terminal device 1010 and the resale-side terminal device 1020 by electromagnetic waves.

Next, the first IC control unit 1712 causes the reader/writer 170 to transmit a request to confirm whether the resale-side terminal device 1020 is capable of retaining the type of the electronic money of the transfer destination having been input by the user of the purchase-side terminal device 1010 to the resale-side terminal device 1020 (S219).

When the resale-side terminal device 1020 receives the request to confirm the type of the electronic money (S220), the second IC control unit 2712 confirms whether the electronic money having been input by the user is the type of the electronic money retainable by the resale-side terminal device 1020.

When confirming that the electronic money having been input by the user is the type (electronic money C in the present embodiment) of the electronic money retainable by the resale-side terminal device 1020, the second IC control unit 2712 transmits, to the purchase-side terminal device 1010, a notification indicating that the electronic money having been input by the user is retainable (S221).

Note here that when the resale-side terminal device 1020 is not capable of retaining the electronic money having been input by the user, the purchase-side terminal device 1010 is notified of the fact. Further, the information regarding the type of the electronic money retainable by the resale-side terminal device 1020 is transmitted to the purchase-side terminal device 1010 together with the notification.

When receiving the notification, the purchase-side terminal device 1010 displays a notification screen for the information regarding the type of the electronic money retainable by the resale-side terminal device 1020 and further displays the input screen shown in FIG. 12(A) again.

When receiving a confirmation result that the type of the electronic money of the transfer destination having been input by the user is retainable by the resale-side terminal device 1020 (S222), the purchase-side terminal device 1010 transmits a request to execute the transfer of the electronic money and the electronic ticket to the application server 1040 (S223).

When receiving the request to execute the transfer (S224), the application server 1040 transmits a request to subtract money corresponding to an amount of the transfer from the electronic money B retained by the purchase-side terminal device 1010 to the remote issuance server 1050 (S225).

Here, in the present embodiment, processing to delete an electronic value and processing to add the electronic value will be called subtraction processing and addition processing, respectively, when the electronic value is electronic money. Further, processing to delete an electronic value and processing to add the electronic value will be called deletion processing and writing processing, respectively, when the electronic value is an electronic ticket.

The remote issuance server 1050 receives the subtraction request (S226) and transmits an instruction to execute the subtraction processing to the purchase-side terminal device 1010 (S227).

When receiving the instruction to execute the subtraction processing in the purchase-side terminal device 1010 (S228), the first control unit 126 causes the first IC control unit 1712 to perform the subtraction processing to subtract 10,000 yen corresponding to the amount of the transfer from the retained electronic money B (S229) and rewrite the data of the electronic money B stored in the first memory unit 1713.

Thus, a first IC chip 171 of the purchase-side terminal device 1010 is remotely controlled by the remote issuance server 1050 (remote function).

When the subtraction processing ends, the purchase-side terminal device 1010 transmits a report on the completion of the subtraction processing to the application server 1040 (S230). The application server 1040 receives the completion report (S231).

Next, the application server 1040 transmits a request to delete the electronic ticket retained by the resale-side terminal device 1020 to the remote issuance server 1050 (S232).

The remote issuance server 1050 receives the deletion request (S233) and transmits an instruction to execute the deletion processing to delete the electronic ticket from the second memory unit 2713 to the purchase-side terminal device 1010 (S234).

The first control unit 126 of the purchase-side terminal device 1010 causes, on the basis of the instruction from the remote issuance server 1050, the reader/writer 170 to transmit an instruction to execute the deletion processing to the resale-side terminal device 1020.

When receiving the instruction to execute the deletion processing in the resale-side terminal device 1020 (S235), the second IC control unit 2712 performs the deletion processing to delete the retained target electronic ticket (S236) and rewrites the data of the electronic ticket stored in the second memory unit 2713.

Thus, a first IC chip 571 of the resale-side terminal device 1020 is remotely controlled by the remote issuance server 1050 via the reader/writer 170 of the purchase-side terminal device 1010 (reader/writer function, remote function).

When the deletion processing ends, the resale-side terminal device 1020 transmits a report on the completion of the deletion processing to the reader/writer 170 of the purchase-side terminal device 1010. When the reader/writer 170 receives the completion report, the first control unit 126 transmits the completion report to the application server 1040 (S237). The application server receives the completion report (S238).

Next, the application server 1040 transmits a request to write the target electronic ticket in the first memory unit 1713 of the purchase-side terminal device 1010 to the remote issuance server 1050 (S239).

The remote issuance server 1050 receives the writing request (S240) and transmits an instruction to execute writing processing to write the electronic ticket to the purchase-side terminal device 1010 (S241).

When the purchase-side terminal device 1010 receives the instruction to execute the writing processing (S242), the first control unit 126 causes the first IC control unit 1712 to execute the writing processing to write the target electronic ticket (S243) and rewrites the data of the first memory unit 1713.

Thus, the first IC chip 171 of the purchase-side terminal device 1010 is remotely controlled by the remote issuance server 1050 (remote function).

When the writing processing ends, the purchase-side terminal device 1010 transmits a report on the completion of the writing processing to the application server 1040 (S244). The application server 1040 receives the completion report (S245).

Next, the application server 1040 transmits an addition request to add the money corresponding to the amount of the transfer to the electronic money C retained by the resale-side terminal device 1020 to the remote issuance server 1050 (S246).

The remote issuance server 1050 receives the addition request (S247) and provides an instruction to execute the addition processing to add the money corresponding to the amount of the transfer to the second memory unit 2713 (S248).

The first control unit 126 of the purchase-side terminal device 1010 causes, on the basis of the instruction from the remote issuance server 1050, the reader/writer 170 to transmit an instruction to execute the addition processing to the resale-side terminal device 1020.

When the resale-side terminal device 1020 receives the instruction to execute the addition processing (S249), the second IC control unit 2712 executes the addition processing to add the money 10,000 yen corresponding to the amount of the transfer to the retained electronic money C (S250) and rewrites the data of the electronic money C stored in the second memory unit 2713.

Thus, the second IC chip 271 of the resale-side terminal device 1020 is remotely controlled by the remote issuance server 1050 via the reader/writer 170 of the purchase-side terminal device 1010 (reader/writer function, remote function).

When the addition processing ends, the resale-side terminal device 1020 transmits a report on the completion of the addition processing to the reader/writer 170 of the purchase-side terminal device 1010. When the reader/writer 170 receives the completion report, the first control unit 126 transmits the completion report to the application server 1040 (S251). The application server 1040 receives the completion report (S252).

The application server 1040 transmits a report on the end of the transfer of the electronic money and the electronic ticket and the completion of the exchange of the electronic money and the electronic ticket to the purchase-side terminal device 1010 (S253). The purchase-side terminal device 1010 receives the report on the completion of the exchange of the electronic money and the electronic ticket (S254), and the report on the completion of the exchange is displayed on the display unit 122.

In addition, the application server 1040 transmits the report on the completion of the exchange of the electronic money and the electronic ticket to the resale-side terminal device 1020 via the reader/writer 170 of the purchase-side terminal device 1010 (S255). The resale-side terminal device 1020 receives the report on the completion of the exchange of the electronic money and the electronic ticket (S256), and the report on the completion of the exchange is displayed on the display unit 222.

The above electronic ticket is offered as, for example, an electronic ticket using a two-dimensional barcode from a service business operator who manages the application server 1040.

In the deletion processing to delete an electronic ticket, the electronic ticket of a two-dimensional barcode stored in the second memory unit 2713 of the second IC chip 271 of the resale-side terminal device 1020 is deleted.

On the other hand, in the writing processing to write an electronic ticket, a barcode different from a deleted two-dimensional barcode is newly issued and added to the electronic ticket and stored in the first memory unit 1713 of the first IC chip 171 of the purchase-side terminal device 1010.

In the present embodiment, the exchange of electronic money and an electronic ticket is allowed by performing near field communication with the purchase-side terminal device 1010 held over the resale-side terminal device 1020 as described above. That is, the exchange of different electronic values is allowed.

In the present embodiment, the transfer of electronic values is not allowed if the purchase-side terminal device (information processing device) and the resale-side terminal device (communication equipment) that exchange the electronic values with each other do not exist in the same place. Therefore, physical restrictions are imposed.

Accordingly, the user of the first terminal device and the user of the second terminal device exist in the same place, and the user of the first terminal device serving as the transfer source of an electronic value and the user of the second terminal device serving as the transfer destination of the electronic value exchange the electronic value with each other by mutual agreement. Thus, the users are allowed to perform the exchange of electronic money and an electronic ticket with a feeling as if they directly transferred actual money or actual goods.

Further, the exchange of electronic money and an electronic ticket is performed using the electronic money and electronic ticket transfer service in the present embodiment. Therefore, a service business operator is allowed to grasp the flow of resale and restrict the resale of an electronic ticket at unreasonable price.

In the above embodiment, the transfer of electronic values is described exemplifying electronic money and an electronic ticket as electronic values. However, the present technology is not limited to this but is also applicable to, for example, the transfer of a coupon serving as an electronic value. Hereinafter, the transfer of a coupon will be described as a third embodiment.

### Third Embodiment

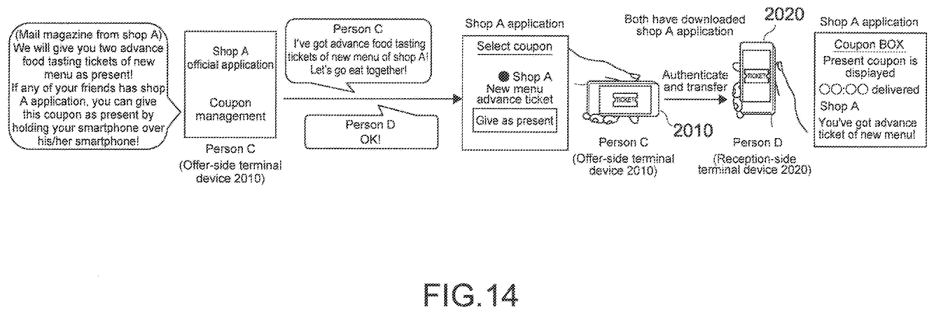

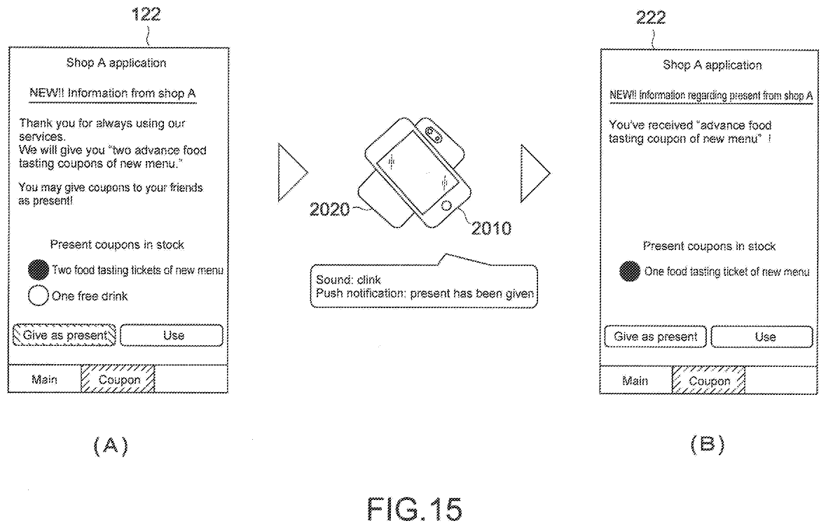

FIG. 9 shows a configuration example of an information processing system 2100 according to the present embodiment. FIG. 14 and FIGS. 15(A) and 15(B) are diagrams for describing the outline of an information processing system in the present embodiment.

In the present embodiment as well, the transfer of an electronic value is allowed between two terminal devices (here, an offer-side terminal device 2010 and a reception-side terminal device 2020) like the above embodiments. In the present embodiment, the electronic value is a coupon, and the transfer of the coupon using the terminal devices is allowed between individuals.

As shown in FIG. 9, the information processing system 2100 is configured to include an application server 2040 serving as an intermediate server, a remote issuance server 2050 serving as a management server, the offer-side terminal device 2010 serving as an information processing device, the reception-side terminal device 2020 serving as communication equipment, and a communication network 30. The same configurations as those of the above embodiments will be denoted by the same signs, and differences will be mainly described.

The application server 2040 includes the same configurations as those shown in FIG. 4. The remote issuance server 2050 includes the same configurations as those shown in FIG. 5.

The offer-side terminal device 2010 includes almost the same configurations as those shown in FIG. 2, and the reception-side terminal device 2020 includes almost the same configurations as those shown in FIG. 10. In both the terminal devices, a shop A official application program 1289 offered by a shop A that is a restaurant is downloaded as an application program and stored in each of program storage units 128 and 228.

The application program 1289 is an application program corresponding to a terminal device in which an IC chip remotely controllable by the remote issuance server is installed.

By executing the shop A official application program, a user is allowed to receive, for example, the services of the shop information regarding the shop A, the acquisition of points resulting from the use of the shop A, new item information, the acquisition of a meal coupon ticket offered by the shop A, or the like.

Here, a case in which a coupon ticket is delivered to others as a service offered by the execution of the shop A official application program will be described.

By executing the shop A official application program, the offer-side terminal device 2010 receives the information regarding the present of a food tasting ticket coupon of a new menu from the shop A as shown in FIG. 12.

The coupon having been received by the offer-side terminal device 2010 is one deliverable to others. Person C who is the user of the offer-side terminal device 2010 is allowed to transfer the coupon to, for example, person D who is the user of the reception-side terminal device 2020.

Person D is allowed to receive the coupon by downloading the shop A official application program in the reception-side terminal device 2020.

As shown in FIG. 15, when a reader/writer 170 activates and near field communication is established with the offer-side terminal device 2010 and the reception-side terminal device 2020 get close to each other, the coupon retained by the offer-side terminal device 2010 becomes transferable to the reception-side terminal device 2020 like the transfer of electronic money from the first terminal device 10 to the second terminal device 20 in the above first embodiment.

FIG. 15(A) is an example of a display screen displayed on a display unit 122 of the offer-side terminal device 2010. FIG. 15(B) is an example of a display screen displayed on a display unit 222 of the reception-side terminal device 2020.

As described above, a coupon may be configured to be transferred as an electronic value.

The respective embodiments of the present technology are described above. However, the present technology is not limited to only the above embodiments but may be, of course, modified in various ways without departing from its spirit.

In the first embodiment, first electronic money is transferred after being converted into second electronic money. In other words, electronic money is transferred after being converted into an electronic value of a different type in the same category of electronic money. The transfer of electronic money after being converted into a different electronic value is not limited to such transfer in the same category.

For example, points accumulated by a user may be transferred to other users after being converted into electronic money. That is, electronic money may be configured to be transferred after being converted into an electronic value of a different category.

Further, in the second embodiment, a mode in which electronic money is exchanged for an electronic ticket is described. However, a mode in which an electronic ticket serving as an electronic value retained by the first terminal device is transferred to the second terminal device without the exchange of electronic money may be, for example, employed. In this case, the electronic ticket is transferred free of charge.

Further, in the above respective embodiments, the information processing device (first terminal device) is configured such that an instruction to activate the reader/writer is provided from the management server (remote issuance server) when the information processing device issues a request to transfer an electronic value, and such that the reader/writer activates on the basis of this instruction. However, the activation of the reader/writer is not limited to this.

For example, without an instruction to activate the reader/writer from the management server, the reader/writer may be configured to activate inside the information processing device through the operation of the display unit of the information processing device by a user.

When the reader/writer activates without an instruction to activate the reader/writer from the management server as described above, the operations of the respective devices constituting the information processing system are operations in which the steps of 3101 to S106 of FIG. 8 are eliminated in a case in which electronic money is transferred after being converted into different electronic money as in, for example, the first embodiment.

Then, in the step of S112 in which a request to execute the transfer of electronic money is transmitted, the execution request is transmitted on the basis of information input by the user to a screen for inputting electronic money transfer information as shown in FIG. 6(A) or FIG. 7(A).

Note that the present technology may also employ the following configurations.

(1) An information processing device including:

a first memory unit on which an electronic value is recorded;

a reader/writer that performs near field communication with communication equipment including a second memory unit;

a communication unit that performs communication with a management server;

a control unit that controls transfer of the electronic value to the communication equipment via the reader/writer; and

an application that causes a user interface related to the transfer of the electronic value to be displayed on a display unit, in which

on the basis of an instruction received from the management server via the communication unit in accordance with an operation of the application, the control unit
deletes the electronic value corresponding to an amount of the transfer from the first memory unit, and
transmits an instruction to the communication equipment via the reader/writer, the instruction transmitted to the communication equipment being an instruction to add the electronic value corresponding to the amount of the transfer to the second memory unit of the communication equipment.

(2) The information processing device according to (1), in which

the control unit activates the reader/writer on the basis of the instruction received from the management server via the communication unit in accordance with the operation of the application.

(3) The information processing device according to (1) or (2), in which

the transfer of the electronic value includes transferring the electronic value after converting the electronic value into an electronic value of a different type.

(4) The information processing device according to any one of (1) to (3), in which

the first memory unit is configured to be capable of recording first electronic money as the electronic value,

the second memory unit is configured to be capable of recording second electronic money of a type different from the first electronic money, and

on the basis of the instruction received from the management server via the communication unit in accordance with the operation of the application, the control unit
deletes the first electronic money corresponding to an amount of transfer from the first memory unit, and
transmits an instruction to the communication equipment via the reader/writer, the instruction transmitted to the communication equipment being an instruction to add, to the second memory unit, second electronic money into which the first electronic money corresponding to the amount of the transfer has been converted.

(5) The information processing device according to any one of (1) to (3), in which

the first memory unit is configured to be capable of recording first electronic money and an electronic ticket as the electronic values,

the second memory unit is configured to be capable of recording second electronic money of a type different from the first electronic money and the electronic ticket, and

on the basis of the instruction received from the management server via the communication unit in accordance with the operation of the application, the control unit
deletes the first electronic money corresponding to an amount of transfer from the first memory unit,
adds the electronic ticket to the first memory unit, and
transmits an instruction to the communication equipment via the reader/writer, the instruction transmitted to the communication equipment being an instruction to add, to the second memory unit, second electronic money into which the first electronic money corresponding to the amount of the transfer has been converted, and delete the electronic ticket from the second memory unit.

(6) The information processing device according to (1) or (2), in which

the electronic value is an electronic ticket.

(7) The information processing device according to (1) or (2), in which

the electronic value is a coupon.

(8) Communication equipment including:

a near field communication unit that performs near field communication with a reader/writer of an information processing device, the information processing device including a first memory unit on which a first electronic value is recorded and the reader/writer and performing communication with a management server; and

a second memory unit on which a second electronic value of a type different from the first electronic value is recorded, in which

the second electronic value corresponding to an amount of transfer is added to the second memory unit via the reader/writer in accordance with an instruction from the management server provided on the basis of a request to transfer an electronic value from the information processing device, the transferring the electronic value including converting the first electronic value recorded on the first memory unit into the second electronic value and transferring the second electronic value to the second memory unit.

(9) A management server including:

a communication unit that receives a request to transfer an electronic value from an information processing device, the transferring the electronic value including transferring the electronic value recorded on a first memory unit of the information processing device including a reader/writer and the first memory unit on which the electronic value is recorded to a second memory unit of communication equipment that performs near field communication with the reader/writer and includes the second memory unit; and

a processing execution unit that instructs, on the basis of the request to transfer the electronic value, the information processing device to delete the electronic value corresponding to an amount of transfer from the first memory unit, and add the electronic value corresponding to the amount of the transfer to the second memory unit of the communication equipment.

(10) The management server according to (9), in which

the first memory unit is configured to be capable of recording first electronic money as the electronic value,

the second memory unit is configured to be capable of recording second electronic money of a type different from the first electronic money, and

on the basis of a request to transfer electronic money from the information processing device, the transferring the electronic money including converting the first electronic money recorded on the first memory unit into the second electronic money and transferring the second electronic money to the second memory unit, the processing execution unit instructs the information processing device to delete the first electronic money corresponding to an amount of transfer from the first memory unit, and add the second electronic money corresponding to the amount of the transfer to the second memory unit.

(11) The management server according to (9), in which

the first memory unit is configured to be capable of recording first electronic money and an electronic ticket as the electronic values,

the second memory unit is configured to be capable of recording second electronic money of a type different from the first electronic money and the electronic ticket, and

on the basis of a request from the information processing device, the request being a request to transfer electronic money and to transfer the electronic ticket to the first memory unit, the electronic ticket being recorded on the second memory unit, the transferring the electronic money including converting the first electronic money recorded on the first memory unit into the second electronic money and transferring the second electronic money to the second memory unit, the processing execution unit instructs the information processing device to delete the first electronic money corresponding to an amount of transfer from the first memory unit, add the electronic ticket to the first memory unit, delete the electronic ticket from the second memory unit, and add the second electronic money corresponding to the amount of the transfer to the second memory unit.

(12) An intermediate server including:

a communication unit that receives a request to transfer an electronic value from an information processing device including a reader/writer and a first memory unit on which the electronic value is recorded, the transferring the electronic value including transferring the electronic value recorded on the first memory unit to a second memory unit of communication equipment that includes the second memory unit and performs near field communication with the reader/writer; and

a processing execution unit that requests, on the basis of the request to transfer the electronic value, the management server to delete the electronic value corresponding to an amount of transfer from the first memory unit, and add the electronic value corresponding to the amount of the transfer to the second memory unit.

(13) The intermediate server according to (12), in which

the first memory unit is configured to be capable of recording first electronic money as the electronic value,

the second memory unit is configured to be capable of recording second electronic money of a type different from the first electronic money, and

on the basis of a request to transfer electronic money from the information processing device, the transferring the electronic money including converting the first electronic money recorded on the first memory unit into the second electronic money and transferring the second electronic money to the second memory unit, the processing execution unit requests the management server to delete the first electronic money corresponding to an amount of transfer from the first memory unit, and add the second electronic money corresponding to the amount of the transfer to the second memory unit.

(14) The intermediate server according to (12), in which

the first memory unit is configured to be capable of recording first electronic money and an electronic ticket as the electronic values,

the second memory unit is configured to be capable of recording second electronic money of a type different from the first electronic money and the electronic ticket, and

on the basis of a request from the information processing device, the request being a request to transfer electronic money and to transfer the electronic ticket to the first memory unit, the electronic ticket being recorded on the second memory unit, the transferring the electronic money including converting the first electronic money recorded on the first memory unit into the second electronic money and transferring the second electronic money to the second memory unit, the processing execution unit requests the management server to delete the first electronic money corresponding to an amount of transfer from the first memory unit, add the second electronic money corresponding to the amount of the transfer to the second memory unit, delete the electronic ticket from the second memory unit, and add the electronic ticket to the first memory unit.

(15) An information processing method of an information processing device that includes a communication unit, a reader/writer, and a first memory unit on which an electronic value is recorded and performs, using the reader/writer, near field communication with communication equipment that includes a second memory unit on which an electronic value is recorded, the information processing method including:

requesting an intermediate server to transfer an electronic value recorded on the first memory unit to the second memory unit via the communication unit;

activating the reader/writer;

performing near field communication with the communication equipment using the reader/writer; and

according to an instruction from the management server provided on the basis of a request made to the management server by the intermediate server in accordance with the request to transfer the electronic value, deleting the electronic value corresponding to an amount of transfer from the first memory unit and transmitting an instruction to the communication equipment via the reader/writer, the instruction transmitted to the communication equipment being an instruction to add the electronic value corresponding to the amount of the transfer to the second memory unit.

(16) An information processing method of a management server that performs communication with an information processing device, the information processing device including a reader/writer that performs near field communication with communication equipment including a second memory unit, and a first memory unit on which an electronic value is recorded, the information processing method including:

receiving a deletion request to delete the electronic value corresponding to an amount of transfer from the first memory unit, the deletion request being transmitted from an intermediate server that receives a request to transfer the electronic value from the information processing device, the transferring the electronic value including transferring the electronic value recorded on the first memory unit to the second memory unit;

instructing, on the basis of the deletion request, the information processing device to delete the electronic value corresponding to the amount of the transfer from the first memory unit;

receiving an addition request to add the electronic value corresponding to the amount of the transfer to the second memory unit, the addition request being transmitted from the intermediate server; and

instructing, on the basis of the addition request, the information processing device to add the electronic value corresponding to the amount of the transfer to the second memory unit.

(17) An information processing method of an intermediate server that performs communication with an information processing device and a management server, the information processing device including a reader/writer that performs near field communication with communication equipment including a second memory unit, and a first memory unit on which an electronic value is recorded, the information processing method including:

receiving a request to transfer the electronic value from the information processing device, the transferring the electronic value including transferring the electronic value recorded on the first memory unit to the second memory unit;

requesting the management server to delete the electronic value corresponding to an amount of transfer from the first memory unit; and

requesting the management server to add the electronic value corresponding to the amount of the transfer to the second memory unit.

### REFERENCE SIGNS LIST

10 first terminal device (information processing device)
20 second terminal device (communication equipment)
40, 1040, 2040 application server (intermediate server)
41, 51 communication unit
43, 53 processing execution unit
50, 1050, 2050 remote issuance server (management server)
121 communication unit
122 display unit
126 first control unit (control unit)
170 reader/writer
272 second communication antenna (near field communication unit)
1010 purchase-side terminal device (information processing device)
1020 resale-side terminal device (communication equipment)
1713 first memory unit
2010 offer-side terminal device (information processing device)
2020 reception-side terminal device (communication equipment)
2713 second memory unit

1. An information processing device comprising:
a first memory unit on which an electronic value is recorded;
a reader/writer that performs near field communication with communication equipment including a second memory unit;
a communication unit that performs communication with a management server;
a control unit that controls transfer of the electronic value to the communication equipment via the reader/writer; and
an application that causes a user interface related to the transfer of the electronic value to be displayed on a display unit, wherein
on a basis of an instruction received from the management server via the communication unit in accordance with an operation of the application, the control unit
deletes the electronic value corresponding to an amount of the transfer from the first memory unit, and
transmits an instruction to the communication equipment via the reader/writer, the instruction transmitted to the communication equipment being an instruction to add an electronic value corresponding to the amount of the transfer to the second memory unit of the communication equipment.

2. The information processing device according to claim 1, wherein
the control unit activates the reader/writer on the basis of the instruction received from the management server via the communication unit in accordance with the operation of the application.

3. The information processing device according to claim 2, wherein
the transfer of the electronic value includes transferring the electronic value after converting the electronic value into an electronic value of a different type.

4. The information processing device according to claim 3, wherein
the first memory unit is configured to be capable of recording first electronic money as the electronic value,
the second memory unit is configured to be capable of recording second electronic money of a type different from the first electronic money, and
on the basis of the instruction received from the management server via the communication unit in accordance with the operation of the application, the control unit
deletes the first electronic money corresponding to an amount of transfer from the first memory unit, and
transmits an instruction to the communication equipment via the reader/writer, the instruction transmitted to the communication equipment being an instruction to add, to the second memory unit, second electronic money into which the first electronic money corresponding to the amount of the transfer has been converted.

5. The information processing device according to claim 1, wherein
the first memory unit is configured to be capable of recording first electronic money and an electronic ticket as the electronic values,
the second memory unit is configured to be capable of recording second electronic money of a type different from the first electronic money and the electronic ticket, and
on the basis of the instruction received from the management server via the communication unit in accordance with the operation of the application, the control unit
deletes the first electronic money corresponding to an amount of transfer from the first memory unit,
adds the electronic ticket to the first memory unit, and
transmits an instruction to the communication equipment via the reader/writer, the instruction transmitted to the communication equipment being an instruction to add, to the second memory unit, second electronic money into which the first electronic money corresponding to the amount of the transfer has been converted, and delete the electronic ticket from the second memory unit.

6. The information processing device according to claim 1, wherein
the electronic value is an electronic ticket.

7. The information processing device according to claim 1, wherein
the electronic value is a coupon.

8. Communication equipment comprising:
a near field communication unit that performs near field communication with a reader/writer of an information processing device, the information processing device including a first memory unit on which a first electronic value is recorded and the reader/writer and performing communication with a management server; and
a second memory unit on which a second electronic value of a type different from the first electronic value is recorded, wherein
the second electronic value corresponding to an amount of transfer is added to the second memory unit via the reader/writer in accordance with an instruction from the management server provided on a basis of a request to transfer an electronic value from the information processing device, the transferring the electronic value including converting the first electronic value recorded on the first memory unit into the second electronic value and transferring the second electronic value to the second memory unit.

9. A management server comprising:
a communication unit that receives a request to transfer an electronic value from an information processing device, the transferring the electronic value including transferring the electronic value recorded on a first memory unit of the information processing device including a reader/writer and the first memory unit on which the electronic value is recorded to a second memory unit of communication equipment that performs near field communication with the reader/writer and includes the second memory unit; and
a processing execution unit that instructs, on a basis of the request to transfer the electronic value, the information processing device to delete the electronic value corresponding to an amount of transfer from the first memory unit, and add the electronic value corresponding to the amount of the transfer to the second memory unit of the communication equipment.

10. The management server according to claim 9, wherein
the first memory unit is configured to be capable of recording first electronic money as the electronic value,
the second memory unit is configured to be capable of recording second electronic money of a type different from the first electronic money, and
on a basis of a request to transfer electronic money from the information processing device, the transferring the electronic money including converting the first electronic money recorded on the first memory unit into the second electronic money and transferring the second electronic money to the second memory unit, the processing execution unit instructs the information processing device to delete the first electronic money corresponding to an amount of transfer from the first memory unit, and add the second electronic money corresponding to the amount of the transfer to the second memory unit.

11. The management server according to claim 9, wherein
the first memory unit is configured to be capable of recording first electronic money and an electronic ticket as the electronic values,
the second memory unit is configured to be capable of recording second electronic money of a type different from the first electronic money and the electronic ticket, and
on a basis of a request from the information processing device, the request being a request to transfer electronic money and to transfer the electronic ticket to the first memory unit, the electronic ticket being recorded on the second memory unit, the transferring the electronic money including converting the first electronic money recorded on the first memory unit into the second electronic money and transferring the second electronic money to the second memory unit, the processing execution unit instructs the information processing device to delete the first electronic money corresponding to an amount of transfer from the first memory unit, add the electronic ticket to the first memory unit, delete the electronic ticket from the second memory unit, and add the second electronic money corresponding to the amount of the transfer to the second memory unit.

12. An intermediate server comprising:
a communication unit that receives a request to transfer an electronic value from an information processing device including a reader/writer and a first memory unit on which the electronic value is recorded, the transferring the electronic value including transferring the electronic value recorded on the first memory unit to a second memory unit of communication equipment that includes the second memory unit and performs near field communication with the reader/writer; and
a processing execution unit that requests, on a basis of the request to transfer the electronic value, the management server to delete the electronic value corresponding to an amount of transfer from the first memory unit, and add the electronic value corresponding to the amount of the transfer to the second memory unit.

13. The intermediate server according to claim 12, wherein
the first memory unit is configured to be capable of recording first electronic money as the electronic value,
the second memory unit is configured to be capable of recording second electronic money of a type different from the first electronic money, and
on a basis of a request to transfer electronic money from the information processing device, the transferring the electronic money including converting the first electronic money recorded on the first memory unit into the second electronic money and transferring the second electronic money to the second memory unit, the processing execution unit requests the management server to delete the first electronic money corresponding to an amount of transfer from the first memory unit, and add the second electronic money corresponding to the amount of the transfer to the second memory unit.

14. The intermediate server according to claim 12, wherein
the first memory unit is configured to be capable of recording first electronic money and an electronic ticket as the electronic values,
the second memory unit is configured to be capable of recording second electronic money of a type different from the first electronic money and the electronic ticket, and
on a basis of a request from the information processing device, the request being a request to transfer electronic money and to transfer the electronic ticket to the first memory unit, the electronic ticket being recorded on the second memory unit, the transferring the electronic money including converting the first electronic money recorded on the first memory unit into the second electronic money and transferring the second electronic money to the second memory unit, the processing execution unit requests the management server to delete the first electronic money corresponding to an amount of transfer from the first memory unit, add the second electronic money corresponding to the amount of the transfer to the second memory unit, delete the electronic ticket from the second memory unit, and add the electronic ticket to the first memory unit.

15. An information processing method of an information processing device that includes a communication unit, a reader/writer, and a first memory unit on which an electronic value is recorded and performs, using the reader/writer, near field communication with communication equipment that includes a second memory unit on which an electronic value is recorded, the information processing method comprising:
requesting an intermediate server to transfer an electronic value recorded on the first memory unit to the second memory unit via the communication unit;
activating the reader/writer;
performing near field communication with the communication equipment using the reader/writer; and
according to an instruction from the management server provided on a basis of a request made to the management server by the intermediate server in accordance with the request to transfer the electronic value, deleting the electronic value corresponding to an amount of transfer from the first memory unit and transmitting an instruction to the communication equipment via the reader/writer, the instruction transmitted to the communication equipment being an instruction to add the electronic value corresponding to the amount of the transfer to the second memory unit.

16. An information processing method of a management server that performs communication with an information processing device, the information processing device including a reader/writer that performs near field communication with communication equipment including a second memory unit, and a first memory unit on which an electronic value is recorded, the information processing method comprising:
receiving a deletion request to delete the electronic value corresponding to an amount of transfer from the first memory unit, the deletion request being transmitted from an intermediate server that receives a request to transfer the electronic value from the information processing device, the transferring the electronic value including transferring the electronic value recorded on the first memory unit to the second memory unit;
instructing, on a basis of the deletion request, the information processing device to delete the electronic value corresponding to the amount of the transfer from the first memory unit;
receiving an addition request to add the electronic value corresponding to the amount of the transfer to the second memory unit, the addition request being transmitted from the intermediate server; and
instructing, on a basis of the addition request, the information processing device to add the electronic value corresponding to the amount of the transfer to the second memory unit.

17. An information processing method of an intermediate server that performs communication with an information processing device and a management server, the information processing device including a reader/writer that performs near field communication with communication equipment including a second memory unit, and a first memory unit on which an electronic value is recorded, the information processing method comprising:
receiving a request to transfer the electronic value from the information processing device, the transferring the electronic value including transferring the electronic value recorded on the first memory unit to the second memory unit;
requesting the management server to delete the electronic value corresponding to an amount of transfer from the first memory unit; and
requesting the management server to add the electronic value corresponding to the amount of the transfer to the second memory unit.
